(19) United States
(12) Patent Application Publication
(10) Pub. No.: US 2012/0251997 A1
(43) Pub. Date: Oct. 4, 2012

(54) STUDENT TERMINAL, ELECTRONIC BLACKBOARD, SERVER, TERMINAL FUNCTION RESTRICTION METHOD AND RECORDING MEDIUM IN WHICH TERMINAL FUNCTION RESTRICTION PROGRAM IS RECORDED

(75) Inventor: Takashi KOJO, Tokyo (JP)

(73) Assignee: CASIO COMPUTER CO., LTD., Tokyo (JP)

(21) Appl. No.: 13/436,116

(22) Filed: Mar. 30, 2012

(30) Foreign Application Priority Data
Mar. 31, 2011 (JP) 2011-077410

(51) Int. Cl. G09B 25/00

(52) U.S. Cl. 434/379

(57) ABSTRACT

Disclosed is an electronic blackboard which communicates with a student terminal which executes a plurality of terminal functions including a blackboard function execution unit to execute any of a plurality of blackboard functions according to a user's operation, a restriction target function deciding unit to decide types of a plurality of terminal functions in which functions thereof are to be restricted in the student terminal according to a type of blackboard function to be executed, and a restriction target functions transmission unit to transmit the types of the plurality of terminal functions in which functions thereof are to be restricted, which are decided by the restriction target function deciding unit, to the student terminal.

### BACKGROUND OF THE INVENTION

1. Field of the Invention

The present invention relates to a student terminal, an electronic blackboard, a server and a recording medium.

2. Description of the Related Art

Conventionally, in the field of education, information display devices called electronic blackboards and student terminals are being used. In classes where such information display devices are used, letters and the like which are input by a teacher in an electronic blackboard are transmitted to student terminals and letters and the like which are input in the student terminals are transmitted to the electronic blackboard.

In a technical field of scientific electronic calculators, there is suggested a technique for restricting its functions at the time of examination.

In the student terminals, various types functions which are highly convenient comparing to scientific electronic calculators are installed. Therefore, even when a teacher tries to conduct classes by making the students display the textbook on their terminals, students can execute functions unrelated to the class or look at other pages on their terminals, not concentrating on the class. Thus, learning efficiency of the students declines.

### SUMMARY OF THE INVENTION

It is, therefore, a main object of the present invention is to provide a student terminal, an electronic blackboard, a server and a recording medium which can prevent such decline in learning efficiency.

In order to solve the above problem, according to one aspect of the present invention, an electronic blackboard which communicates with a student terminal which executes a plurality of terminal functions includes a blackboard function execution unit to execute any of a plurality of blackboard functions according to a user's operation, a restriction target function deciding unit to decide types of a plurality of terminal functions in which functions thereof are to be restricted in the student terminal according to a type of blackboard function to be executed, and a restriction target functions transmission unit to transmit the types of the plurality of terminal functions in which functions thereof are to be restricted, which are decided by the restriction target function deciding unit, to the student terminal.

Further, according to another aspect of the present invention, an electronic blackboard which communicates with a student terminal which executes a plurality of terminal functions includes a blackboard display switching execution unit to execute any of a plurality of blackboard display switching according to a user's operation, a switched state restriction target function deciding unit to decide types of a plurality of terminal functions in which functions thereof are to be restricted in the student terminal according to a type of blackboard display switching to be executed, and a restriction target functions transmission unit to transmit the types of the plurality of terminal functions in which functions thereof are to be restricted, which are decided by the switched state restriction target function deciding unit, to the student terminal.

Further, according to another aspect of the present invention, a student terminal which executes a plurality of terminal functions and communicates with an electronic blackboard includes a blackboard function receiving unit to receive a type of blackboard function to be executed in the electronic blackboard, a restriction target function deciding unit to decide types of a plurality of terminal functions in which functions thereof are to be restricted in the student terminal according to the type of blackboard function to be executed, and a restriction target function prohibiting unit to prohibit execution of the plurality of terminal functions in which functions thereof are to be restricted, which are decided by the restriction function deciding unit.

Further, according to another aspect of the present invention, a server which communicates respectively with an electronic blackboard and a student terminal which executes a plurality of terminal functions includes a blackboard function receiver unit to receive a type of blackboard function to be executed in the electronic blackboard among a plurality of blackboard functions, a restriction target function deciding unit to decide types of a plurality of terminal functions in which functions thereof are to be restricted in the student terminal according to the type of blackboard function which is received, and a restriction target functions transmission unit to transmit the types of the plurality of terminal function in which functions thereof are to be restricted, which are decided by the restriction target function deciding unit, to the student terminal.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a diagram showing a schematic configuration of a class support system;

FIG. 2 is a block diagram showing a schematic configuration of an electronic blackboard;

FIG. 3 is a block diagram showing a schematic configuration of a student terminal;

FIG. 4A is a diagram showing a blackboard function-wise function restriction table and a blackboard display tag-wise function restriction table;

FIG. 4B is a diagram showing a blackboard function-wise function restriction table and a blackboard display tag-wise function restriction table;

FIG. 5A is a flowchart showing a flow of electronic blackboard processing;

FIG. 5B is a flowchart showing a flow of electronic blackboard processing;

FIG. 6A is a flowchart showing a flow of student terminal processing;

FIG. 6B is a flowchart showing a flow of student terminal processing;

FIG. 7A is a diagram showing a display content of a display;

FIG. 7B is a diagram showing a display content of a display;

FIG. 7C is a diagram showing a display content of a display;

FIG. 7D is a diagram showing a display content of a display;

FIG. 8A is a diagram showing a display content of a display;

FIG. 8B is a diagram showing a display content of a display;

FIG. 8C is a diagram showing a display content of a display;

FIG. 8D is a diagram showing a display content of a display;

FIG. 9A is a diagram showing a display content of a display;

FIG. 9B is a diagram showing a display content of a display;

FIG. 9C is a diagram showing a display content of a display;

FIG. 9D is a diagram showing a display content of a display;

FIG. 10A is a diagram showing a display content of a display;

FIG. 10B is a diagram showing a display content of a display;

FIG. 10C is a diagram showing a display content of a display;

FIG. 10D is a diagram showing a display content of a display;

FIG. 11A is a diagram showing a display content of a display;

FIG. 11B is a diagram showing a display content of a display;

FIG. 11C is a diagram showing a display content of a display;

FIG. 11D is a diagram showing a display content of a display;

FIG. 12A is a diagram showing a display content of a display;

FIG. 12B is a diagram showing a display content of a display;

FIG. 12C is a diagram showing a display content of a display;

FIG. 12D is a diagram showing a display content of a display;

FIG. 13A is a flowchart showing a flow of electronic blackboard processing according to the second embodiment;

FIG. 13B is a flowchart showing a flow of electronic blackboard processing according to the second embodiment;

FIG. 14A is a flowchart showing a flow of student terminal processing according to the second embodiment;

FIG. 14B is a flowchart showing a flow of student terminal processing according to the second embodiment;

FIG. 15 is a block diagram showing a schematic configuration of the electronic blackboard according to the third embodiment;

FIG. 16 is a block diagram showing a schematic configuration of the student terminal according to the third embodiment;

FIG. 17 is a block diagram showing a schematic configuration of a server; and

FIG. 18A is a flowchart showing a flow of classroom server processing.

FIG. 18B is a flowchart showing a flow of classroom server processing.

### DESCRIPTION OF THE PREFERRED EMBODIMENTS

Hereinafter, an example of embodiment of the present invention will be described in detail with reference to the appended drawings. However, the scope of the invention is not limited to the examples shown in the drawings in any way.

### First Embodiment

First, the first embodiment of the present invention will be described.

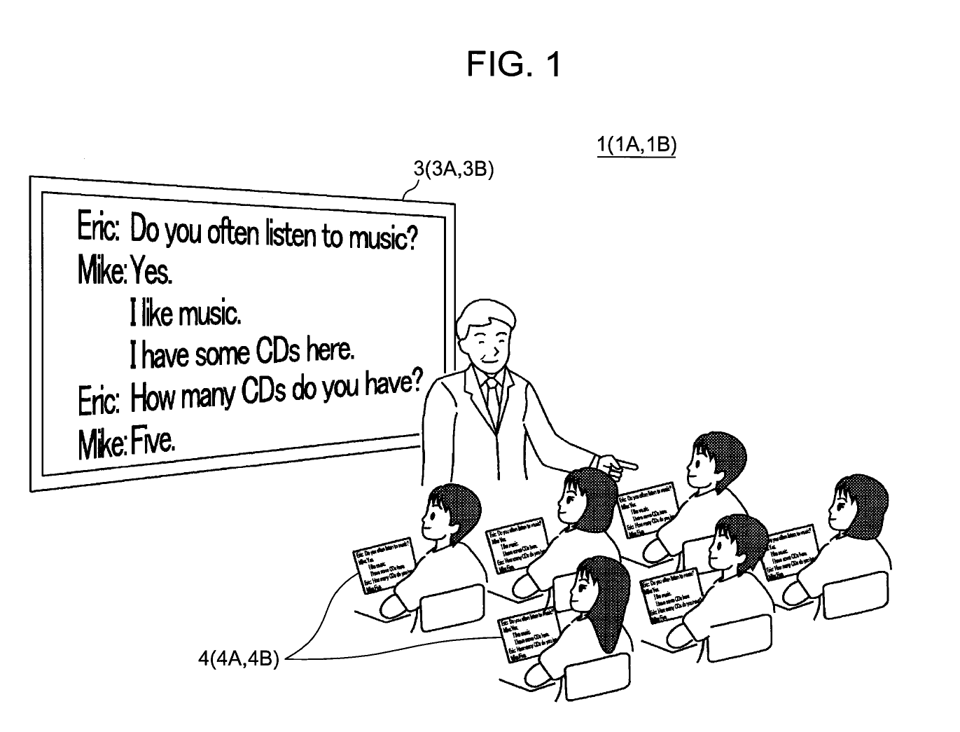

FIG. 1 is a diagram showing a schematic configuration of the class support system 1 according to this embodiment.

As described in the drawing, the class support system 1 of this embodiment is provided with an electronic blackboard 3 and student terminals 4.

### [Blackboard]

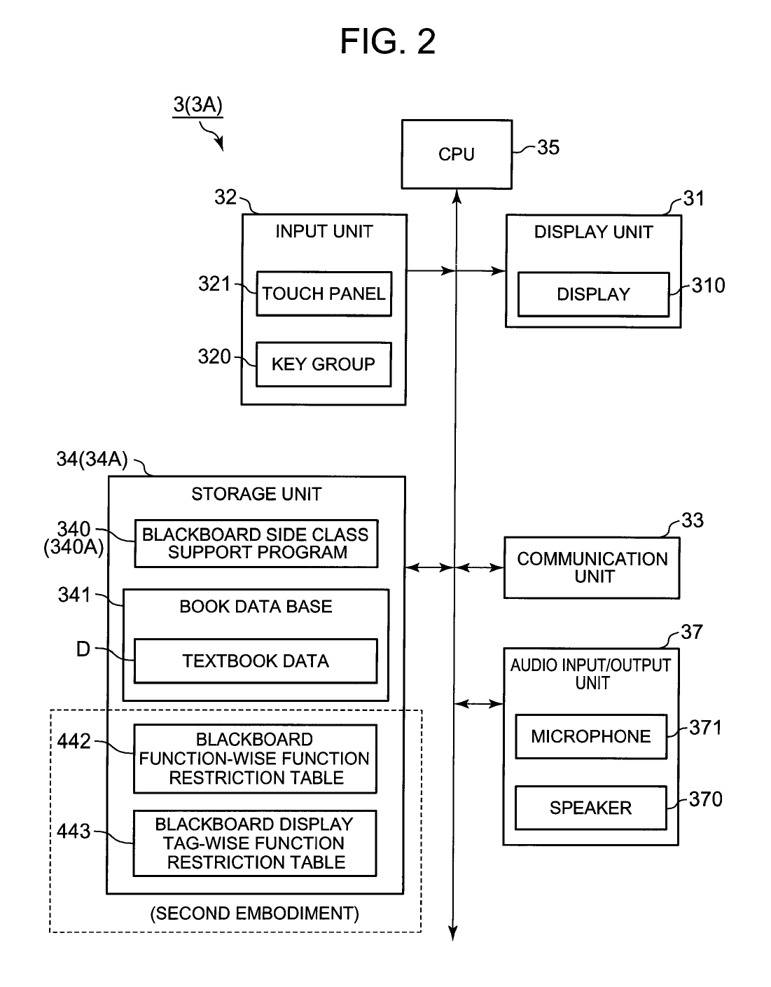

The electronic blackboard 3 is to be set in a classroom to be used in classes, and as shown in FIG. 2, the electronic blackboard 3 is constituted of a display unit 31, an input unit 32, an audio input/output unit 37, a communication unit 33, a storage unit 34, a CPU 35 and so forth.

The display unit 31 includes a display 310, and various types of information are to be displayed in the display 310 based on display signals input from the CPU 35. Here, the display 310 according to this embodiment is formed integrally with a so-called touch panel 321 and can receive touch operations performed by a user (teacher).

The input unit 32 includes a group of keys 320, the above mentioned touch panel 321, and the input unit 32 outputs signals corresponding to the pushed keys and positions in the touch panel 321 to the CPU 35.

The audio input/output unit 37 includes a speaker 370 and a microphone 371. The speaker 370 is q part for outputting audio based on audio output signals input from the CPU 35. The microphone 371 is a part for taking in audio from outside based on audio take-in signals input from the CPU 35.

The communication unit 33 is for carrying out data communication with the student terminals 4, and in this embodiment, the communication unit 33 carries out a wireless communication.

The storage unit 34 is a memory for storing programs and data for realizing various types of functions of the electronic blackboard 3 and for functioning as a work area of the CPU 35. In this embodiment, a blackboard side class support program 340 and a book data base 341 are stored in the storage unit 34.

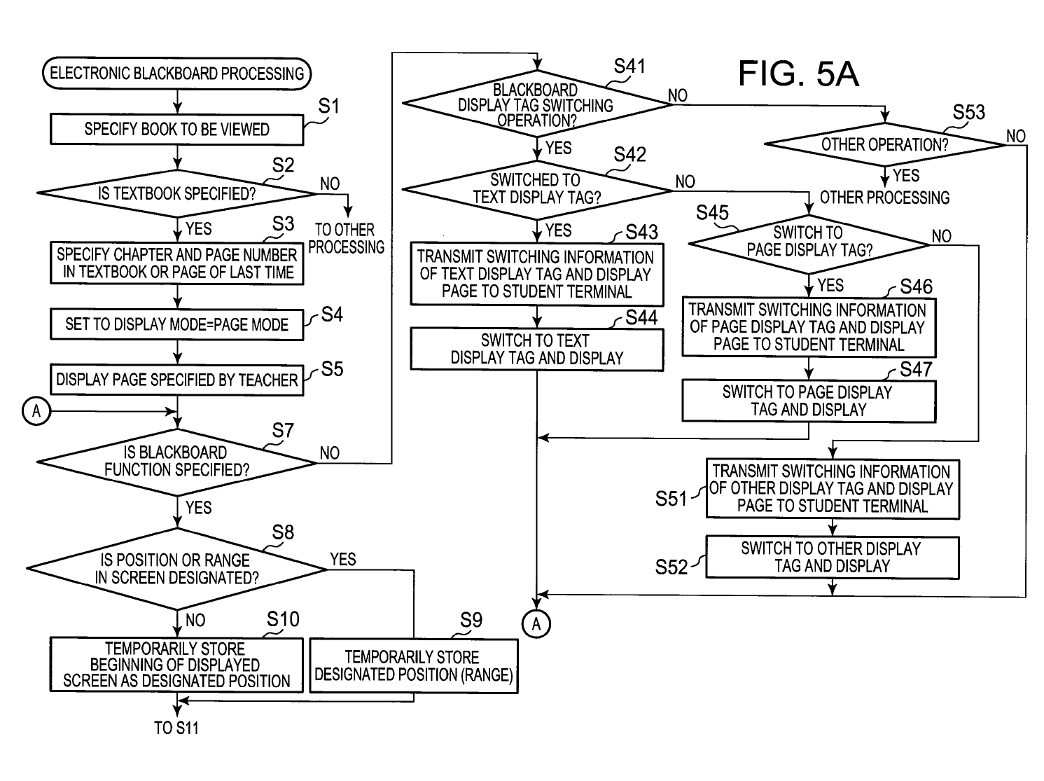

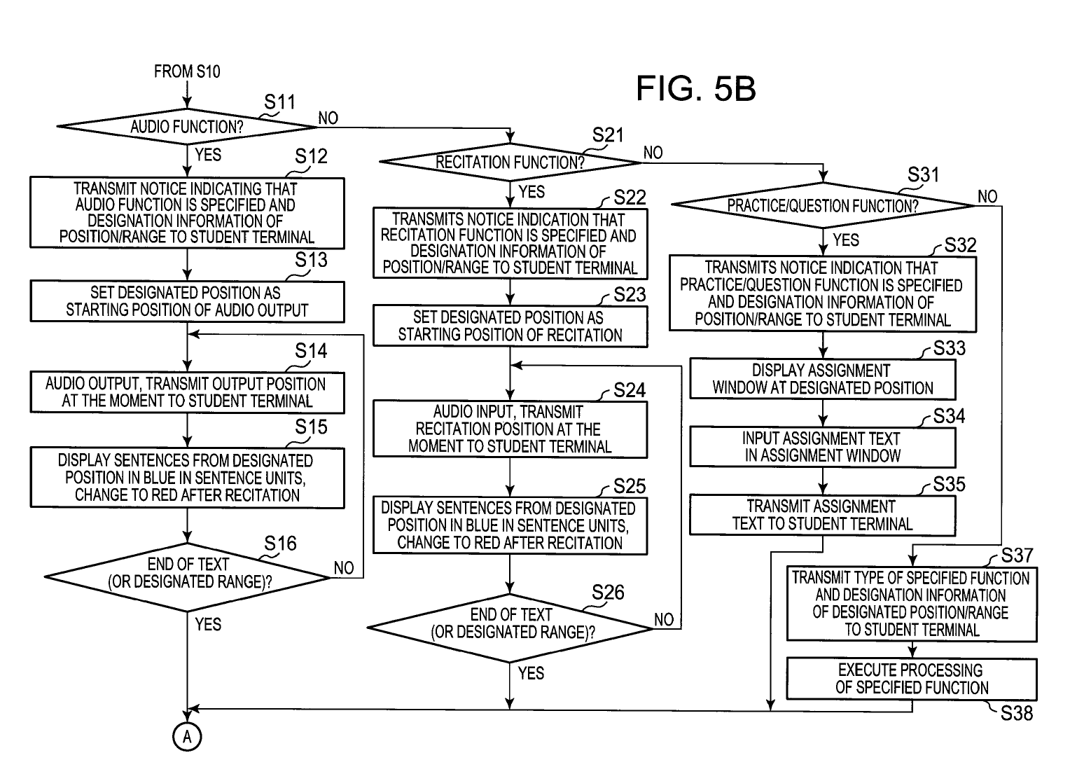

The blackboard side class support program 340 is a program to make the CPU 35 execute the after-mentioned electronic blackboard processing (see FIGS. 5A and 5B).

Data relating to books to be used in classes are stored in the book data base 341, and for example, textbook data D relating to each of the textbooks are stored. Here, the textbook data D according to this embodiment is configured so that the text portion and the image portion of each page can be displayed separately.

The CPU 35 integrally controls the electronic blackboard 3 by carrying out processing based on a predetermined program according to an input instruction and carrying out transmission and the like of instructions and data to each functional unit. In particular, the CPU 35 reads out various types of programs stored in the storage unit 34 in accordance with operation signals and the like which are input from the input unit 32 and the microphone 371 and executes processing according to the programs. Then, the CPU 35 arbitrarily outputs the processing results to the display unit 31 and the speaker 370.

### [Student Terminal]

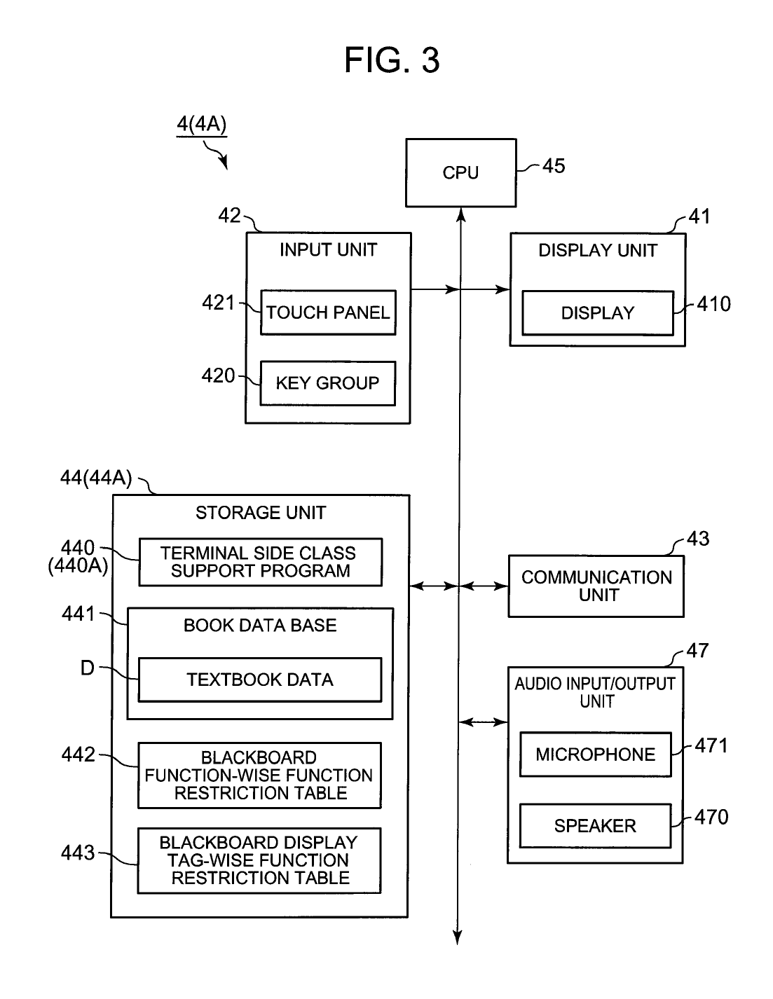

The student terminals 4 are to be owned by the students in a classroom and used in classes, and as shown in FIG. 3, each of the student terminals 4 is constituted of a display unit 41, an input unit 42, an audio input/output unit 47, a communication unit 43, a storage unit 44, a CPU 45 and so forth.

The display unit 41 includes a display 410, and various types of information are to be displayed in the display 410 based on display signals input from the CPU 45. Here, the display 410 according to this embodiment is formed integrally with a so-called touch panel 421 and can receive touch operations performed by a user (student).

The input unit 42 includes a group of keys 420 and the above mentioned touch panel 421, and the input unit 42 outputs signals corresponding to the pushed keys and positions in the touch panel 421 to the CPU 45.

The audio input/output unit 47 includes a speaker 470 and a microphone 471. The speaker 470 is a part for outputting audio based on audio output signals input from the CPU 45. The microphone 471 is a part for taking in audio from outside based on audio take-in signals input from the CPU 45.

The communication unit 43 is for carrying out data communication with the electronic blackboard and other student terminals 4, and in this embodiment, the communication unit 43 carries out a wireless communication. Further, the communication unit 43 is an operation detection device in the present invention, and the communication unit 43 detects an operation performed with respect to the electronic blackboard 3 based on information transmitted from the electronic blackboard 3.

The storage unit 44 is a memory for storing programs and data for realizing various types of functions of the student terminal 4 and for functioning as a work area of the CPU 45. In this embodiment, a terminal side class support program 440, a book data base 441, a blackboard function-wise function restriction table 442, a blackboard display tag-wise function restriction table 443 and so forth are stored in the storage unit 44.

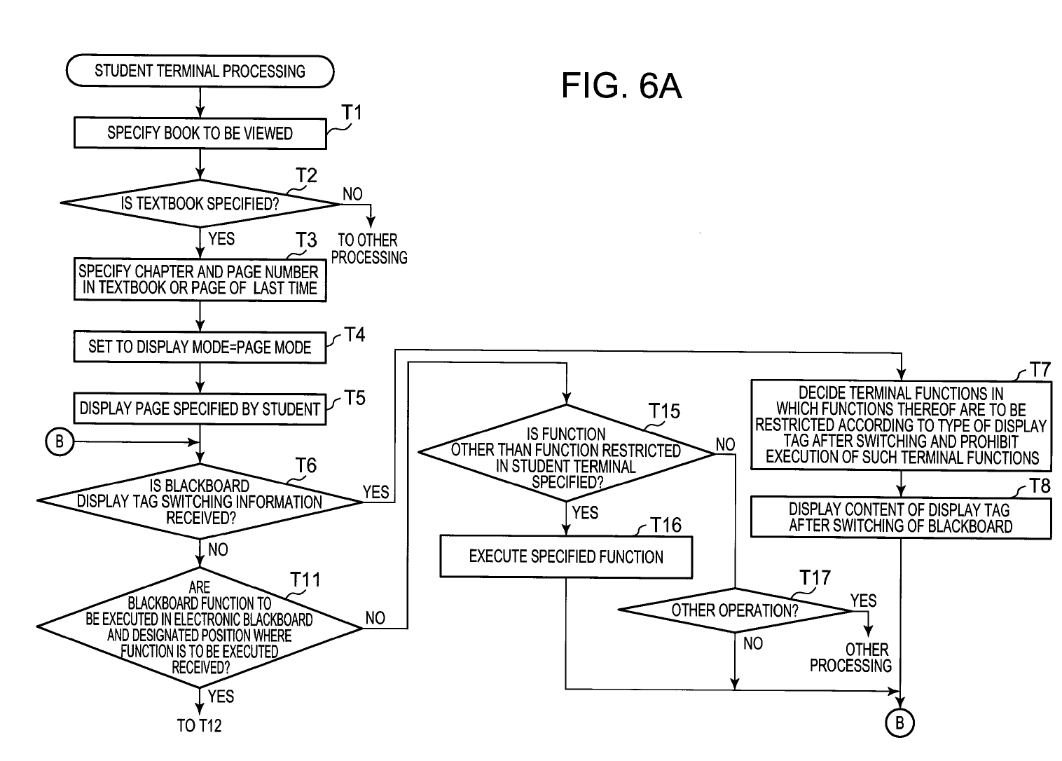

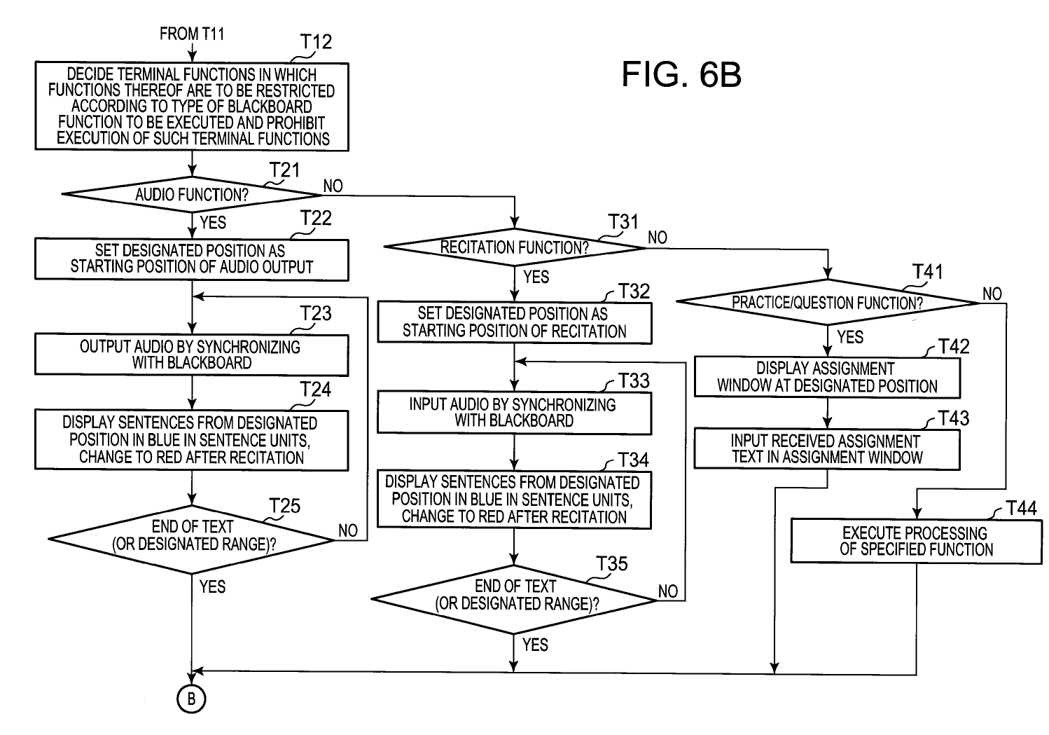

The terminal side class support program 440 is a program to make the CPU 45 execute the after-mentioned student terminal processing (see FIGS. 6A and 6B).

Data relating to books to be used in classes are stored in the book data base 441, and for example, textbook data D relating to each of the textbooks are stored.

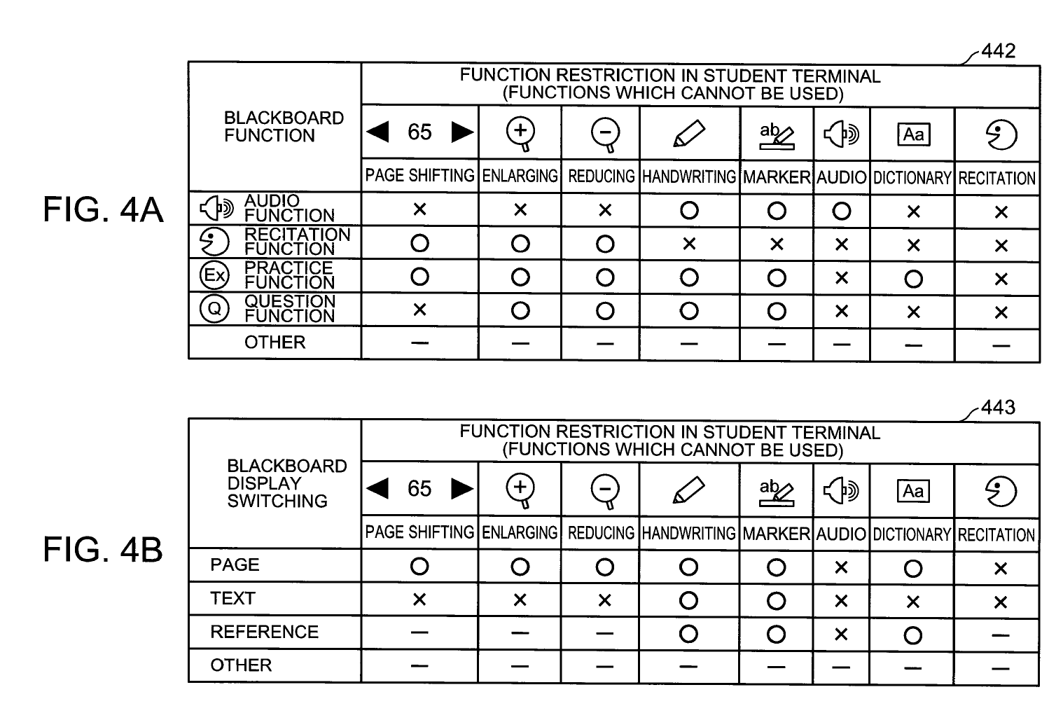

The blackboard function-wise function restriction table 442 and the blackboard display tag-wise function restriction table 443 are operation/restriction function correspondence storage devices, and as shown in FIGS. 4A and 4B, types of restriction target functions which are to be prohibited in the student terminal 4 among a plurality of terminal functions which can be executed in the student terminal 4 are stored by being corresponded to types of operations performed with respect to the electronic blackboard 3. In the after-mentioned second embodiment, the blackboard function-wise function restriction table 442 and the blackboard display tag-wise function restriction table 443 are to be stored in the electronic blackboard of FIG. 2.

Here, as for terminal functions of the student terminal 4 according to this embodiment, there are page shifting function, zoom function, handwriting input function, marker function, dictionary function, audio output function, recitation function and so forth. Among the above, the page shifting function is a function for switching pages to be displayed, and the zoom function is a function for scaling the display content. Further, the handwriting input function is a function to carry out input according to user's handwriting operations, and the marker function is a function for drawing a marker line in a text. Furthermore, the dictionary function is a function to search a letter string in a dictionary and is realized by the conventionally known dictionary data base and dictionary search program. Moreover, the audio output function is a function to audio output the specified part in a text, and the recitation function is a function to identify and display the text part where being recited and audio recognized. Here, in FIGS. 4A and 4B, “◯” indicates that the function is permitted to be executed, and “X” indicates that the function is prohibited from being executed. In particular, when the audio output function is the blackboard function to be executed, the terminal functions to be restricted in the student terminal 4 include the page shifting, enlarging, reducing, dictionary and recitation functions. Further, when the blackboard function to be executed is the recitation function, the terminal functions to be restricted in the student terminal 4 include the handwriting, marker, audio output, dictionary and recitation functions. Furthermore, when the blackboard function to be executed is the practice function, the terminal functions to be restricted in the student terminal 4 include the audio output and recitation functions. Moreover, when the blackboard function to be executed is the question function, the terminal functions to be restricted in the student terminal 4 include the page switching, audio output, dictionary and recitation functions. When the blackboard function to be executed is the audio output function, the terminal functions to be restricted in the student terminal 4 do not need to include all of the page switching, enlarging, reducing, dictionary and recitation functions, and it is sufficient that at least two of them are included. Similarly, when the blackboard function to be executed is the recitation function, the terminal functions to be restricted in the student terminal 4 do not need to include all of the handwriting, marker, audio output, dictionary and recitation functions, and it is sufficient that at least two of them are included. Further, when the blackboard function to be executed is the question function, the terminal functions to be restricted in the student terminal 4 do not need to include all of the page shifting, audio output, dictionary and recitation functions, and it is sufficient that at least two of them are included.

Among the blackboard function-wise function restriction table 442 and the blackboard display tag-wise function restriction table 443, in the blackboard function-wise function restriction table 442, the specifying operations to be carried out for executing a plurality of types of blackboard functions in the after-mentioned electronic blackboard processing (see FIGS. 5A and 5B) are stored by each of them being corresponded with the types of restriction target functions (the terminal functions to be restricted in the student terminal 4), as shown in FIG. 4A. In other word, in the blackboard function-wise function restriction table 442, types of restriction target functions are associated with each type of blackboard functions. Here, in this embodiment, practice function and question function are applied in addition to the above mentioned page switching function, zoom function, handwriting input function, marker function, dictionary function, audio output function and recitation function as the plurality of types of blackboard functions. Here, the practice function is a function to make the student solve the question given by the teacher. Further, the question function is a function to make the student solve the question described in the textbook as an assignment.

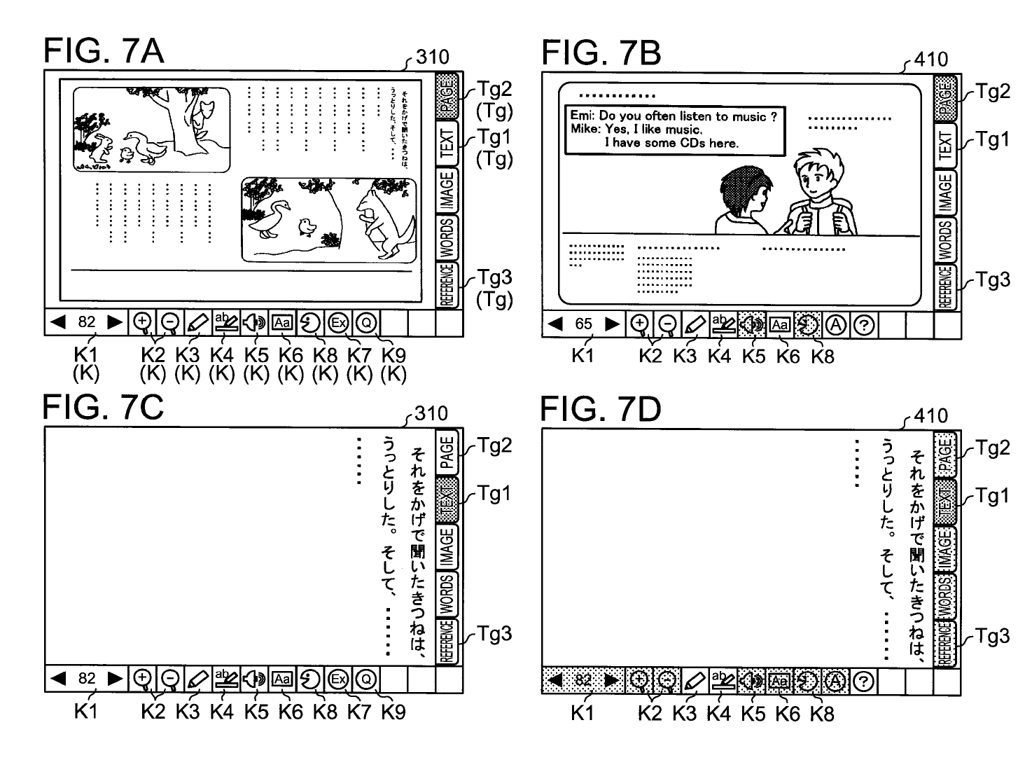

Moreover, in the blackboard display tag-wise function restriction table 443, the switching operations (specifying operation) to be performed with respect to a plurality of types of display tags Tg (see FIG. 7) for switching the display content in the after-mentioned electronic blackboard processing (see FIGS. 5A and 5B) are stored by being corresponded with types of restriction target functions, as shown in FIG. 4B. In other words, in the blackboard display tag-wise function restriction table 443, each of the types of display tags Tg (types of blackboard display switching) is associated with types of restriction target functions.

The CPU 45 integrally controls the student terminal 4 by carrying out processing based on a predetermined program according to an input instruction and carrying out transmission and the like of instructions and data to each functional unit. In particular, the CPU 45 reads out various types of programs stored in the storage unit 44 in accordance with operation signals and the like which are input from the input unit 42 and the microphone 471 and executes processing according to the programs. Then, the CPU 45 arbitrarily outputs the processing results to the display unit 41 and the speaker 470.

### [Operation]

### (Electronic Blackboard Processing)

Next, electronic blackboard processing performed by the electronic blackboard 3 among operations of the class support system 1 will be described with reference to FIG. 5A and FIG. 5B.

FIG. 5A and FIG. 5B are flowcharts for explaining an operation of the electronic blackboard processing which is executed by the CPU 35 reading out the blackboard side class support program 340 from the storage unit 34.

In the electronic blackboard processing, the CPU 35 first receives an operation to specify a book to be viewed by a user (teacher) (step S1) and determines whether the specified book is a textbook (step S2).

When it is determined that the specified book is not a textbook in step S2 (step S2; No), the CPU 35 moves on to other processing.

Further, when it is determined that the specified book is a textbook in step S2 (step S2; Yes), the CPU 35 receives an operation to specify a chapter and a page number in the textbook or an operation to specify the page which was displayed last in the previous electronic blackboard processing from a user (teacher) (step S3).

Next, the CPU 35 sets the display mode of the display 310 to the page mode (step S4). Here, page mode is a mode for displaying the text and the image included in the textbook data D together. In particular, this is a mode for displaying the same content as the paper-based textbook.

Next, the CPU 35 makes the display 310 display the page specified in step S3 among the pages in the textbook (hereinafter, called “specified textbook”) specified in step S1 (step S5).

At this time, the CPU 35 displays a plurality of display tags Tg for switching the display content along the right edge of the display 310 (see, FIG. 7A). More in particular, the CPU 35 displays the page display tag Tg2, text display tag Tg1, reference display tag Tg3 and so forth as the plurality of display tags Tg and displays the page display tag Tg2 in a selected state. Here, the page display tag Tg2 is a display tag for setting the display mode to the page mode and displaying the page in the textbook as it is, the text and the images being displayed together. Further, the text display tag Tg1 is a display tag for setting the display mode to the text mode and only displaying the text. Furthermore, the reference display tag Tg3 is a display tag for displaying reference information (a column article and the like).

At this time, the CPU 35 displays a plurality of soft keys K for instructing execution of a predetermined blackboard function along the lower edge of the display 310 (see FIG. 7A). In particular, the CPU 35 displays page switching key K1 for executing the page switching function, zoom key K2 for executing the zoom function, handwriting input key K3 for executing the handwriting input function, marker key K4 for executing the marker function, audio key K5 for executing the audio output function, dictionary key L6 for executing the dictionary function, reading (recitation) key K8 for executing the reading (recitation) function, practice key K7 for executing the practice function, question key K9 for executing the question function and so forth as the plurality of soft keys K.

Next, the CPU 35 determines whether execution of a blackboard function is specified by a user (teacher) in the electronic blackboard 3 (step S7).

When it is determined that execution of a blackboard function is selected in step S7 (step S7; Yes), the CPU 35 determines whether a position or a range in the displayed text is to be designated (step S8). However, in step S8, the CPU 35 may determine whether a position or a range is already designated.

When it is determined that a position or a range in the text is designated in step S8 (step S8; Yes), the CPU 35 temporarily stores the designated position or the designated range (step S9) and thereafter, moves onto the after-mentioned step S11.

On the other hand, when it is determined that a position or a range in the text is not to be designated in step S8 (step S8; No), the CPU 35 temporarily stores the beginning of the display text as the designated position (step S10).

Next, the CPU 35 determines whether the audio output function is specified as the blackboard function (step S11).

When it is determined that the audio output function is specified in step S11 (step S11; Yes), the CPU 35 transmits a notice indicating that the audio output function is specified and the designated position (or designated range) in the text to the student terminal 4 (step S12).

Next, the CPU 35 sets the designated position (or beginning of the designated range) as the starting position of audio output (step S13) and makes the speaker 370 output the audio (step S14). Further, the CPU 35 transmits the position information of the text part being audio output at the moment to the student terminal 4.

Then, the CPU 35 displays the sentence which is target for audio output in blue and changes the display color of the part in the sentence where audio output thereof is done to red (step S15).

Next, the CPU 35 determines whether audio output is performed to the end of the text (or to the end of the designated range) (step S16). When it is determined that audio output is not performed to the end of the text (step S16; No), the CPU 35 moves on to the above mentioned step S14, and on the other hand, when it is determined that audio output is performed to the end of the text (step S16; Yes), the CPU 35 moves on to the above mentioned step S7.

Moreover, when it is determined that the audio output function is not specified in step S11 (step S11; No), the CPU 35 determines whether the recitation function is specified (step S21).

When it is determined that the recitation function is specified in step S21 (step S12; Yes), the CPU 35 transmits a notice indicating that the recitation function is specified and the designated position (or designated range) in the text to the student terminal 4 (step S22).

Next, the CPU 35 sets the designated position (or beginning of the designated range) as the starting position of recitation (step S23), and makes the microphone 371 input audio to perform audio recognition (step S24). Further, at this time, the CPU 35 transmits the position information of the text part being recited at the moment to the student terminal 4.

Next, the CPU 35 display the sentence which is target for recitation in blue and changes the display color of the part in the sentence where recitation thereof is done to red (step S25).

Then, the CPU 35 determines whether recitation is performed to the end of the text (or to the end of the designated range) (step S26). When it is determined that the recitation is not performed to the end of the text (step S26; No), the CPU 35 moves on to the above mentioned step S24, and on the other hand, when it is determined that the recitation is performed to the end of the text (step S26; Yes), the CPU 35 moves on to the above mentioned step S7.

Further, when it is determined that the recitation function is not specified in step S21 (step S21; No), the CPU 35 determines whether the practice/question function is specified (step S31).

When it is determined that the practice/question function is specified in step S31 (step S31; Yes), the CPU 35 transmits a notice indicating that the practice/question function is specified and the designated position (or designated range) in the text to the student terminal 4 (step S32).

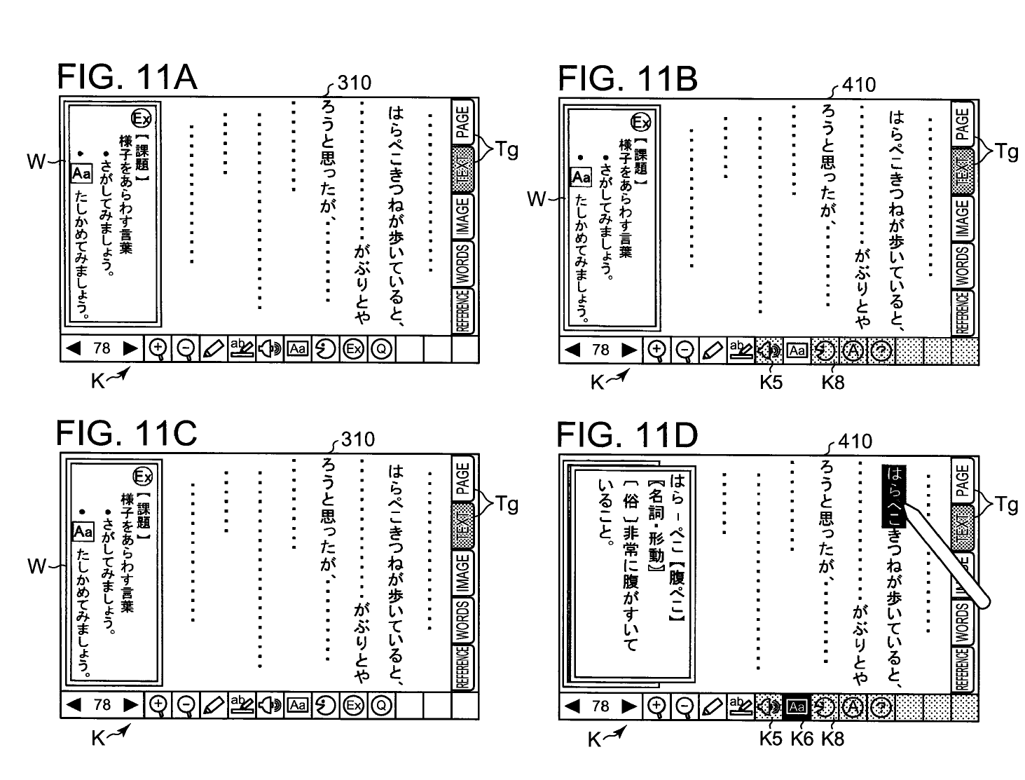

Next, the CPU 35 displays an assignment window W (see FIG. 11) at the designated position (or at the end of the designated range) (step S33).

Then, the CPU 35 displays an assignment text in the assignment window W (step S34). In particular, at this time, the CPU 35 displays the assignment described in the textbook in the assignment window W when the practice function is specified. On the other hand, the CPU 35 displays an assignment text input by a user (teacher), an assignment text which is targeted for copy and paste operation and the like in the assignment window W when the question function is specified.

Next, after the CPU 35 transmits the assignment text to the student terminal 4 and displays the assignment text there (step S35), the CPU 35 moves on to the above mentioned step S7.

Further, when it is determined that the practice/question function is not specified in step S31 (step S31; No), the CPU 35 transmits the type of specified blackboard function and the designated position (or designated range) in the text to the student terminal 4 (step S37).

Then, the CPU 35 executed the processing of the specified function (step S38) and moves on to the above mentioned step S7. Here, the page switching function, zoom function, handwriting input function, marker function, dictionary function and the like are included as the functions to be executed in step S38.

Further, when it is determined that execution of a blackboard function is not specified by a user (teacher) in step S7 (step S7; No), the CPU 35 determines whether switching operation of display tags Tg is performed (step S41).

When it is determined that switching operation of display tags Tg is performed in step S41 (step S41; Yes), the CPU 35 determines whether switching operation is performed with respect to the text display tag Tg1 (step S42).

When it is determined that switching operation is performed with respect to the text display tag Tg1 in step S42 (step S42; Yes), the CPU 35 transmits a notice indicating that switching to the text display tag Tg1 is performed and the page number of the page being displayed at the moment to the student terminal 4 (step S43).

Next, the CPU 35 sets the display mode of the display 310 to the text mode, and makes the display 310 only display the text on the page which is being display at the moment, that is, the CPU 35 makes the display 310 display the content of the text display tag Tg1 (step S44), and moves on to the above mentioned step S7. Here, the text mode is a mode for only displaying the text included in the textbook data D.

When it is determined that switching operation is not performed with respect to the text display tag Tg1 in step S42 (step S42; No), the CPU 35 determines whether switching operation is performed with respect to the page display tag Tg2 (step S45).

When it is determined that switching operation is performed with respect to the page display tag Tg2 in step S45 (step S45; Yes), the CPU 35 transmits a notice that switching to the page display tag Tg2 is performed and the page number of the page being displayed at the moment to the student terminal 4 (step S46).

Next, the CPU 35 sets the display mode of the display 310 to the page mode, and makes the display 310 display the page being displayed at the moment as it is, that is, the CPU 35 makes the display 310 display the content of the page display tag Tg2 (step S47) and moves on to the above step S7.

Further, when it is determined that switching operation is not performed with respect to the page display tag Tg2 in step S45, that is, when switching operation is performed with respect to a display tag Tg other than the text display tag Tg1 and the page display tag Tg2 (step S45; No), the CPU 35 transmits the type of the display tag Tg to which switching operation is performed and the page number of the page being displayed at the moment to the student terminal 4 (step S51), makes the display 310 display the content of this display tag Tg (step S52) and moves on to the above mentioned step S7.

Further, when it is determined that switching operation is not performed with respect to a display tag Tg in step S41 (step S41; No), the CPU 35 determines whether other operation is performed (step S53). When it is determined that other operation is performed (step S53; Yes), the CPU 35 carries out the processing according to the operation, and on the other hand, when it is determined that other operation is not performed (step S53; No), the CPU 35 moves on to the above mentioned step S7.

### (Student Terminal Processing)

Next, the student terminal processing performed in the student terminal 4 among operations of the class support system 1 will be described with reference to FIG. 6A and FIG. 6B.

FIG. 6A and FIG. 6B are flowcharts for explaining the operation of the student terminal processing which is executed by the CPU 45 reading out the terminal side class support program 440 from the storage unit 44.

In the student terminal processing, the CPU 45 first receives an operation to specify a book to be viewed from a user (student) (step T1) and determines whether the specified book is a textbook (step T2).

When it is determined that the specified book is not a textbook in step T2 (step T2; No), the CPU 45 moves on to other processing.

Further, when it is determined that the specified book is a textbook in step T2 (step T2; Yes), the CPU 45 receives an operation to specify a chapter and a page number in the textbook or an operation to specify the page which was displayed last in the previous student terminal processing from a user (student) (step T3).

Next, the CPU 45 sets the display mode of the display 410 to the page mode (step T4).

Next, the CPU 45 makes the display 310 display the page specified in step T3 among the pages in the specified textbook specified in step T1 (step T5). At this time, the CPU 45 displays a plurality of display tags Tg for switching the display content along the right edge of the display 310 and displays the soft keys K for instruction execution of terminal functions along the lower edge of the display 410 (see FIG. 7B).

Here, page switching key K1 for executing the page switching function, zoom key K2 for executing the zoom function, handwriting input key K3 for executing the handwriting input function, marker key K4 for executing the marker function, audio key K5 for executing the audio output function, dictionary key L6 for executing the dictionary function, recitation key K8 for executing the recitation function and so forth are included as the soft keys K to be displayed in this embodiment.

Next, the CPU 45 determines whether a notice indicating that switching operation (specifying operation) is performed with respect to display tags Tg and the page number of the page being displayed in the electronic blackboard 3 at the moment are received from the electronic blackboard 3 (step T6). When it is determines that a notice indicating that switching operation (specifying operation) is performed with respect to display tags Tg and the page number of the page being displayed in the electronic blackboard 3 at the moment are received (step T6; Yes), the CPU 45 reads out the types of restriction target functions corresponding the type of the display tag Tg after switching (restriction target functions corresponding the specifying operation of a display tag Tg) from the blackboard display tag-wise function restriction table 443 and prohibits the execution of the restriction target functions in the student terminal (step T7). Further, at this time, the CPU 45 displays the soft keys K corresponding to the restriction target functions by shading the keys in yellow to show that the functions are restricted.

Next, the CPU 45 resets the display mode of the display 410 according to the type of the display tag Tg after switching, and makes the display 410 display the content of the display tag Tg after switching in the electronic blackboard 3 (step T8) and moves on to the above mentioned step T6.

When it is determined that a notice indicating that switching operation with respect to a display tag Tg is performed is not received from the electronic blackboard 3 in step T6 (step T6; No), the CPU 45 determines whether a notice indicating that the execution of a blackboard function is specified and the designated position (or designated range) in the text are received from the electronic blackboard 3 (step T11).

When it is determined that a notice indicating that the execution of a blackboard function is specified and the designated position (or designated range) in the text are received in step T11 (step T11; Yes), the CPU 45 reads out the types of a plurality of terminal functions which are restriction targets (restriction target functions corresponding to the specifying operation of blackboard function) corresponding to the type of received blackboard function (blackboard function to be executed in the electronic blackboard 3) from the blackboard function-wise function restriction table 442, decides the plurality of terminal function to be restricted and prohibits execution of the restriction target functions in the student terminal (step T12). Further, the CPU 45 displays the soft keys K corresponding to the restriction target functions by shading the keys in yellow to show that the functions are restricted.

Next, the CPU 45 determines whether the audio output function is specified as the blackboard function (step T21). When it is determined that the audio output function is specified as the blackboard function (step T21; Yes), the CPU 45 sets the designated position (or beginning of the designated rage) as the starting position of audio output (step T22) and makes the speaker 470 output audio by synchronizing with the electronic blackboard 3 (step T23).

Next, the CPU 45 displays the sentence which is target for audio output in blue and changes the display color of the sentence part where audio output thereof is done to red (step T24).

Next, the CPU 45 determines whether audio output is performed to the end of the text (or to the end of the designated range) (step T25). When it is determined that audio output is not performed to the end of the text (step T25; No), the CPU 45 moves on to the above mentioned step T23, and on the other hand, when it is determined that audio output is performed to the end of the text (step T25; Yes), the CPU 45 moves on to the above mentioned step T6.

Moreover, when it is determined that the audio output function is not specified in step T21 (step T21; No), the CPU 45 determines whether the recitation function is specified (step T31).

When it is determined that the recitation function is specified in step T31 (step T31; Yes), the CPU 45 sets the designated position (or beginning of the designated range) as the starting position of recitation (step T32), makes the microphone 471 input audio by synchronizing with the electronic blackboard 3 to perform audio recognition (step T33).

Next, the CPU 45 display the sentence target for recitation in blue and changes the display color of the sentence part where recitation thereof is done to red (step T34).

Then, the CPU 45 determines whether recitation is performed to the end of the text (or the end of the designated range) (step T35). When it is determined that the recitation is not performed to the end of the text (step T35; No), the CPU 35 moves on to the above mentioned step T33, and on the other hand, when it is determined that the recitation is performed to the end of the text (step T35; Yes), the CPU 35 moves on to the above mentioned step T6.

Further, when it is determined that the recitation function is not specified in step T31 (step T31; No), the CPU 45 determines whether the practice/question function is specified (step T41).

When it is determined that the practice/question function is specified in step T41 (step T41; Yes), the CPU 45 displays an assignment window W at the designated position (or at the end of the designated range) (step T42).

Next, the CPU 45 displays an assignment text which is received from the electronic blackboard 3 in the assignment window W (step T43) and moves on to the above mentioned step T6.

When it is determined that the practice/question function is not specified in step T41 (step T41; No), the CPU 45 executes the processing of the function specified in the electronic blackboard 3 (step T44) and moves on to the above mentioned step T6. Here, the function similar to that in the above step S38 is executed in step T44.

Further, when it is determined that a notice indicating that the execution of a blackboard function is specified and the designated position (or designated range) in the text are not received in step T11 (step T11; No), the CPU 45 determines whether a terminal function other than the restriction target functions is specified (execution is instructed) in the student terminal 4 (step T15).

When it is determined that a terminal function other than the restriction target functions is specified in step T15 (step T15; Yes), the CPU 45 executed the specified function (step T16) and thereafter, moves on to the above mentioned step T6.

When it is determined that a terminal function other than the restriction target functions is not specified in step T15 (step T15; No), the CPU 45 determines whether other operation is performed (step T17). When it is determined that other operation is not performed (step T17; No), the CPU 45 moves on to the above mentioned step T6, and on the other hand, when it is determined that other operation is performed (step T17; Yes), the CPU 45 moves on to other processing.

### [Operation Example]

Next, operation of the class support system 1 will be described in detail with reference to the drawings.

First, when a user (teacher) carries out an operation to specify a Japanese language textbook in the electronic blackboard 3 (step S1, step S2; Yes) and carries out an operation to specify “82” for specification of a chapter and page number in the textbook (step S3), the display mode of the display 310 is set to the page mode (step S4) and page 82 of the specified textbook “Japanese language” is to be displayed in the display 310 as shown in FIG. 7A (step S5). Further, at this time, the page display tag Tg2, the text display tag Tg1, the reference display tag Tg3 and the like are displayed along the right edge of the display 310, and the page switching key k1, the zoom key K2, the handwriting input key K3, the marker key K4, the audio key K5, the dictionary key K6, the reading (recitation) key K8, the practice key K7, the question key K9 and the like are displayed along the lower edge of the display 310.

Similarly, when a student carries out an operation to specify an English textbook in a student terminal 4 (step T1, step T2; Yes) and carries out an operation to specify the page (here, page 65) which was displayed last in the previous student terminal processing (step T3), the display mode of the display 410 is set to the page mode (step T4) and page 65 in the specified textbook “English” is to be displayed in the display 410 as shown in FIG. 7B (step T5). Further, at this time, the page switching key k1, the zoom key K2, the handwriting input key K3, the marker key K4, the audio key K5, the dictionary key K6, the reading (recitation) key K8 and the like are displayed along the lower edge of the display 410 as the soft keys K for executing the terminal functions in the student terminal 4. Moreover, the page display tag Tg2, the text display tag Tg1, the reference display tag Tg3 and the like are displayed along the right edge of the display 410.

Next, when a user (teacher) performs switching operation with respect to the text display tag Tg1 in the electronic blackboard 3 (step S42; Yes), a notice indicating that switching to the text display tag Tg1 is performed and the page number “82” of the page displayed at the moment are transmitted to the student terminal 4 (step S43) and thereafter, the display mode of the display 310 in the electronic blackboard 3 is set to the text mode and only the text in page “82” which is being displayed at the moment is to be displayed in the display 310 as shown in FIG. 7C (step S44).

On the other hand, in the student terminal 4, after a notice indicating that switching operation is performed with respect to the text display tag Tg1 in the electronic blackboard 3 and the page number “82” of the page being displayed in the electronic blackboard 3 are received (step T6; Yes), the types of restriction target functions corresponding to the text display tag Tg1 after switching (here, functions other than the handwriting input function and the marker function, see the second row in FIG. 4B) are read out from the blackboard display tag-wise function restriction table 443 and execution of the restriction target functions is prohibited in the student terminal (step T7). Further, at this time, the soft keys K (keys other than the handwriting input key K3 and the marker key K4) corresponding to the restriction target functions (functions other than the handwriting input function and the marker function) are displayed by being shaded in yellow to shown that the functions are restricted as shown in FIG. 7D. Here, in the drawing, the shaded regions show that operations with respect to the soft keys K and the display tags Tg in such regions are not effective and execution of the functions are prohibited. Moreover, in this example of operation, execution of the audio output function and the recitation function are prohibited in the student terminal 4 at the time shown in FIG. 7A.

Then, the display mode of the display 410 is set to the text mode according to the type of the display tag Tg (text display tag) after switching and the content of the display tag Tg (text display tag) after switching is to be displayed in the display 410 (step T8).

Next, a user (teacher) says to the student “Let's listen to the audio. What kind of a big brother is the fox? Mark what you find.” and specifies the audio output function by the audio key 5 in the electronic blackboard 3 (step S11; Yes), and a notice indicating that the audio output function is specified and the designated position in the text (here, the beginning position of the text displayed in the display 310) are transmitted to the student terminal 4 (step S12).

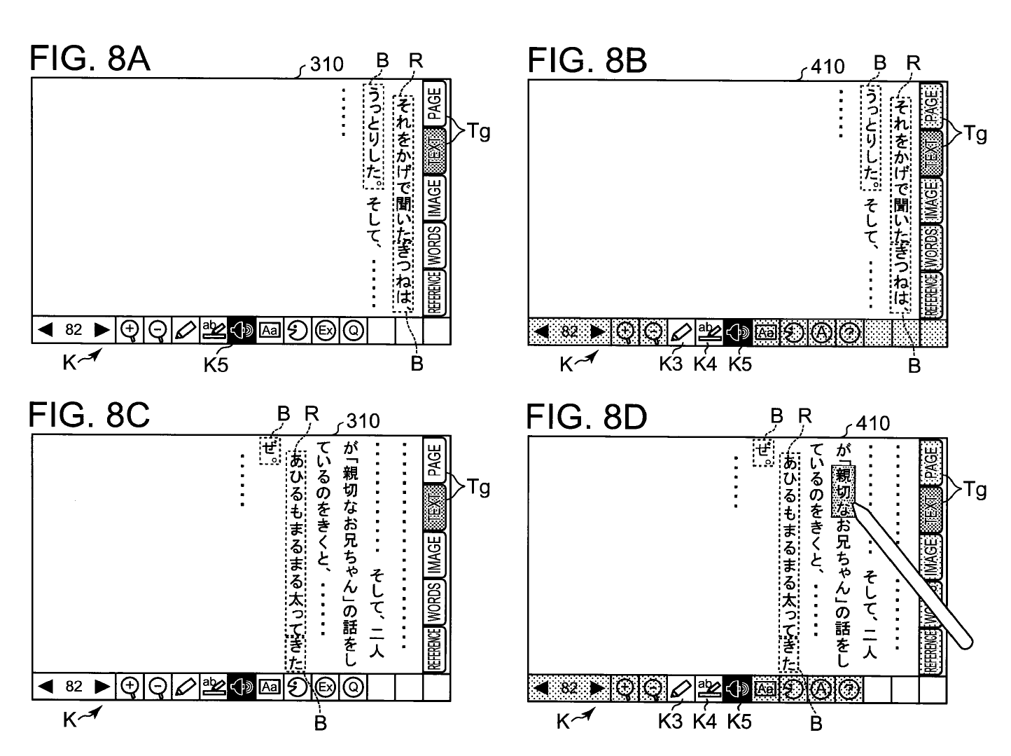

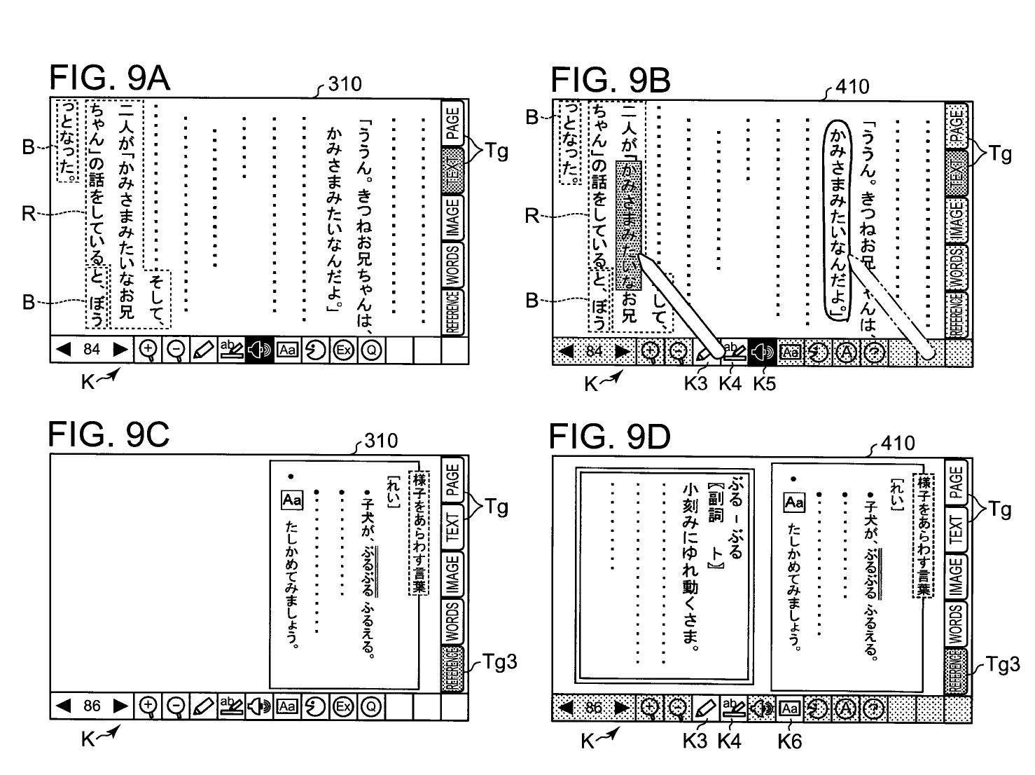

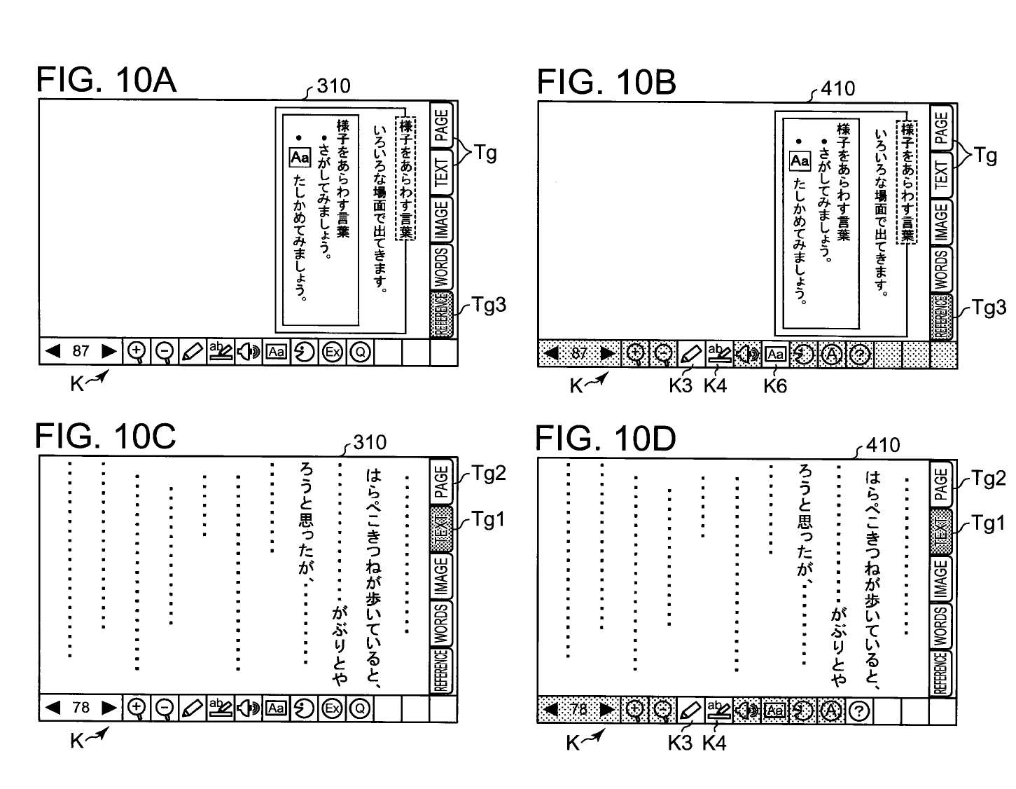

Next, the designated position is set as the starting position of audio output (step S13) and audio is to be output from the speaker 370 (step S14), and also, the position information of the text part being audio output at the moment is to be transmitted to the student terminal 4. Here, as shown in FIGS. 8A, 8C and 9A, the sentence which is target for audio output is displayed in blue and the display color of the text part where the audio output thereof is done is changed to red (step S15). In the drawings, the areas encircled by dotted lines in the display screen indicate that the words in the areas are displayed in colors corresponding to the symbol associated with each area (“B”: blue, “R”: red).

On the other hand, in the student terminal 4, it is determined that a notice indicating that the execution of a blackboard function (audio output function) is specified and the designated position in the text are received (step T11; Yes) and the types of restriction target functions (functions other than handwriting input function, marker function and audio output function, see first row in FIG. 4A) corresponding to the type of specified blackboard function (audio output function) are read out from the blackboard function-wise function restriction table 442 and execution of the restricted target functions are prohibited in the student terminal (step T12). Further, at this time, the soft keys K (keys other than handwriting input key K3, marker key k4 and audio key K5) corresponding to the restriction target functions (functions other than handwriting input function, marker function and audio output function) are displayed by being shaded in yellow to show that the functions are restricted as shown in FIG. 8B.

Next, it is determined that the audio output function is specified as the blackboard function (step T21; Yes), the designated position is set as the starting position of audio output (step T22) and audio is to be output from the speaker 470 by being synchronized with the electronic blackboard 3 (step T23). At this time, as shown in FIGS. 8B, 8D and 9B, the sentence which is target for audio output is displayed in blue and the display color of the sentence part where audio output thereof is done is changed to red (step T24). Here, FIG. 8B shows the display content in the student terminal 4 when the content as shown in FIG. 8A is displayed in the electronic blackboard 3, FIG. 8D shows the display content in the student terminal 4 when the content as shown in FIG. 8C is displayed in the electronic blackboard 3 and FIG. 9B shows the display content in the student terminal 4 when the content as shown in FIG. 9A is displayed in the electronic blackboard 3.

Further, as shown in FIGS. 8D and 9B, when a user (student) specifies the marker function by the marker key K4 (step T15; Yes) and draw a marker line at the part “ [symbol] (kind)” or the part “ [symbol] [symbol] [symbol] (like a god)” in the text in this state, such parts are to be display by being marked (step T16). Furthermore, as shown in FIG. 9B, when a user (student) specifies the handwriting input function by the handwriting input key K3 (step T15; Yes) and performs a handwriting to circle the part “ [symbol] [symbol] [symbol] [symbol] (is like a god)” in the text, such input is to be displayed (step T16).

Next, when a user (teacher) performs switching operation with respect to the reference display tag Tg3 in the electronic blackboard 3 (step S45; No), the type of a display tag Tg (reference display tag) to which switching operation is performed and the page number “84” of the page displayed at the moment are transmitted to the student terminal 4 (step S51) and the content of the display tag Tg (here, reference information just after the page shown at the moment) is to be displayed in the display 310 as shown in FIG. 9C (step S52).

On the other hand, in the student terminal 4, after a notice indicating that switching operation is performed with respect to the reference display tag Tg3 in the electronic blackboard 3 and the page number “84” of the page displayed in the electronic blackboard 3 are received (step T6; Yes), the types of restriction target function (here, functions other than handwriting input function, marker function and dictionary function, see third row in FIG. 4B) corresponding to the reference display tag Tg3 after switching are read out from the blackboard display tag-wise function restriction table 443 and execution of the restriction target functions are prohibited in the student terminal (step T7). At this time, as shown in FIG. 9D, soft keys K (keys other than handwriting input key K3, marker key k4 and dictionary key K6) corresponding to the restriction target functions (functions other than handwriting input function, marker function and dictionary function) are displayed by being shaded in yellow to show that the functions are restricted.

Then, the display mode of the display 410 is set according to the type of the display tag Tg after switching (reference display tag) and the content of the display tag Tg after switching (reference display tag) is to be displayed in the display 410 (step T8).

Next, when a user (teacher) executes the page shifting function by the page switching key K1 in the electronic blackboard 3 and instructs to display the next page, the type of the specified blackboard function (page shifting function) and the like are transmitted to the student terminal 4 (step S37), and the processing of the page shifting function is executed to display page 87 as shown in FIG. 10A (step S38) and the process moves on to the above mentioned step S7. Here, in this example of operation, the teacher carries out a copy operation with respect to the part “ [symbol] [symbol] [symbol] [symbol] [symbol] [symbol] (words to describe condition, let's find, let's check)” in the reference information.

On the other hand, also in the student terminal 4, processing of the page shifting function is executed to display page 87 as shown in FIG. 10B (step T44).

Next, when the teacher says to the student “The words to explain conditions of movements are called adverbs. Now, let's go back to the text and find adverbs.” and performs switching operation with respect to the text display tag Tg1 in the electronic blackboard 3 (step S42; Yes) and further executes the page shifting function by the page switching key K1 and instructs to display page 78, the display mode of the display 310 is set to the text mode and only the text in page “78” is to be displayed in the display 310 as shown in FIG. 10C (step S44).

On the other hand, in the student terminal 4, a notice indicating that switching operation is performed with respect to the text display tag Tg1 in the electronic blackboard 3 and the like are received (step T6; Yes), the types of restriction target functions corresponding to the text display tag Tg1 after switching are read out from the blackboard display tag-wise function restriction table 443, and the execution of restriction target functions are prohibited in the student terminal (step T7). Further, as shown in FIG. 10D, the soft keys K (keys other than handwriting input key K3 and marker key K4) corresponding to the restriction target functions are displayed by being shaded in yellow to shown that the functions are restricted. Further, the display mode of the display 410 is set to the text mode according to the type of the display tag Tg after switching (text display tag) and the content of the display tag Tg after switching (text display tag) is to be displayed in the display 410 (step T8).

Next, when a user (teacher) specifies the practice function by the practice key K7 in the electronic blackboard 3 (step S31; Yes), a notice indicating that the practice function is specified and the designated position in the text are transmitted to the student terminal 4 (step S32) and thereafter, an assignment window W is to be displayed at the designated position as shown in FIG. 11A (step S33). Then, the assignment text “ [symbol] [symbol] [symbol] [symbol] [symbol] [symbol] (words to describe conditions, let's find, let's check)” is to be displayed in the assignment window W according to the paste operation performed by a user (teacher) (step S34).

On the other hand, in the student terminal 4, it is determined that a notice indicating that the execution of a blackboard function (practice function) is specified and the designated position in the text are received (step T11; Yes), the types of restriction target functions (audio output function, recitation function and the like, see fourth row in FIG. 4A) corresponding to the type of the specified blackboard function (practice function) are read out from the blackboard function-wise function restriction table 442 and execution of the restriction target functions are prohibited in the student terminal (step T12). As shown in FIG. 11B, the soft keys K (audio key K5, reading key K8 and the like) corresponding to the restriction target functions are displayed by being shaded in yellow to show that the functions are restricted. Next, it is determined that the question function is specified (step T41; Yes), and an assignment window W is displayed at the designated position (step T42) and the assignment text which is received from the electronic blackboard 3 is to be displayed in the assignment window W (step T43).

Next, when a user (student) specifies the dictionary function by the dictionary key K6 (step T15; Yes) and reverse displays the letter string “ [symbol] (hungry)” in the text as shown in FIG. 11D, dictionary search is to be carried out for the letter string “ [symbol] (hungry)” and the detected description information is to be displayed (step T16). Here, FIG. 11C shows the display content in the electronic blackboard 3 when the content as shown in FIG. 11D is displayed in the student terminal 4.

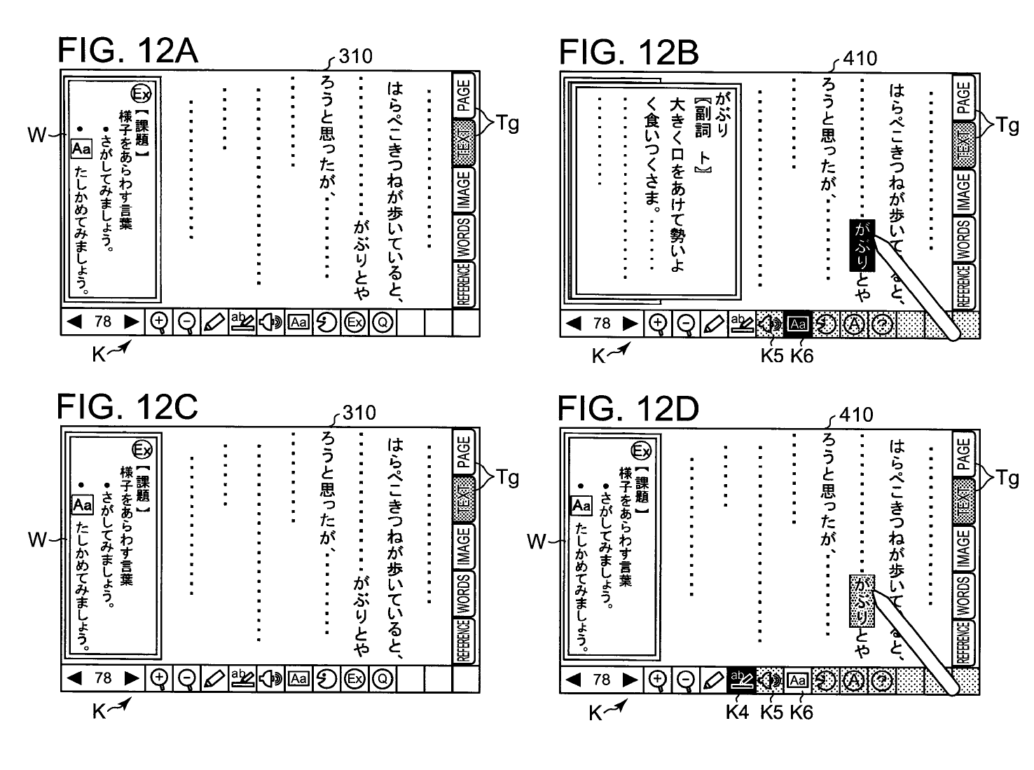

Next, when the dictionary function is specified by the dictionary key K6 so that a user (student) understands that the word “ [symbol] (hungry)” is not an adverb and search for an adverb in the text again (step T15; Yes) and the letter string “ [symbol] [symbol] (gulp)” in the text is reverse displayed and specified as shown in FIG. 12B, the letter string “ [symbol] (gulp)” is to be searched in the dictionary and the detected description information is to be displayed (step T16). Here, FIG. 12A shows the display content in the electronic blackboard 3 when the content as shown in FIG. 12B is displayed in the student terminal 4.

Then, when a user (student) understands that the word “ [symbol] [symbol] (gulp)” is an adverb and specifies the marker function by the marker key K4 as shown in FIG. 12D (step T15; Yes) to draw a marker line at the part “big bite” in the text, the part will be displayed by being marked (step T16). Here, FIG. 12C shows the display content in the electronic blackboard 3 when the content as shown in FIG. 12D is displayed in the student terminal 4.

As described above, according to the electronic blackboard 3 of this embodiment, as shown in FIG. 4, steps T7 and T12 of FIG. 6A, FIG. 6B, FIGS. 7 to 12 and the like, the types of restriction target functions to be prohibited in the student terminal 4 among a plurality of terminal functions in the student terminal 4 are stored in the blackboard function-wise function restriction table 442 and the blackboard display tag-wise function restriction table 443 by being corresponded with the types of operations in the electronic blackboard 3, and when an operation is carried out in the electronic blackboard 3, execution of the restriction target functions corresponding to the operation are to be prohibited in the student terminal 4. Therefore, students can be prevented from executing function not related to the class or looking at other pages on their terminals, not concentrating on the blackboard. Thus, declining is learning efficiency can be prevented.

### Second Embodiment

Next, the second embodiment of the present invention will be described. Here, when parts in the second embodiment corresponding to the same parts in the above described first embodiment are configured similarly among the two embodiments, same symbols are used for those parts and descriptions thereof are omitted.

As shown in FIG. 1, the class support system 1A according to this embodiment is provided with an electronic blackboard 3A and student terminals 4A.

As shown in FIG. 2, the blackboard-side class support program 340A is stored in the storage unit 34A of the electronic blackboard 3A.

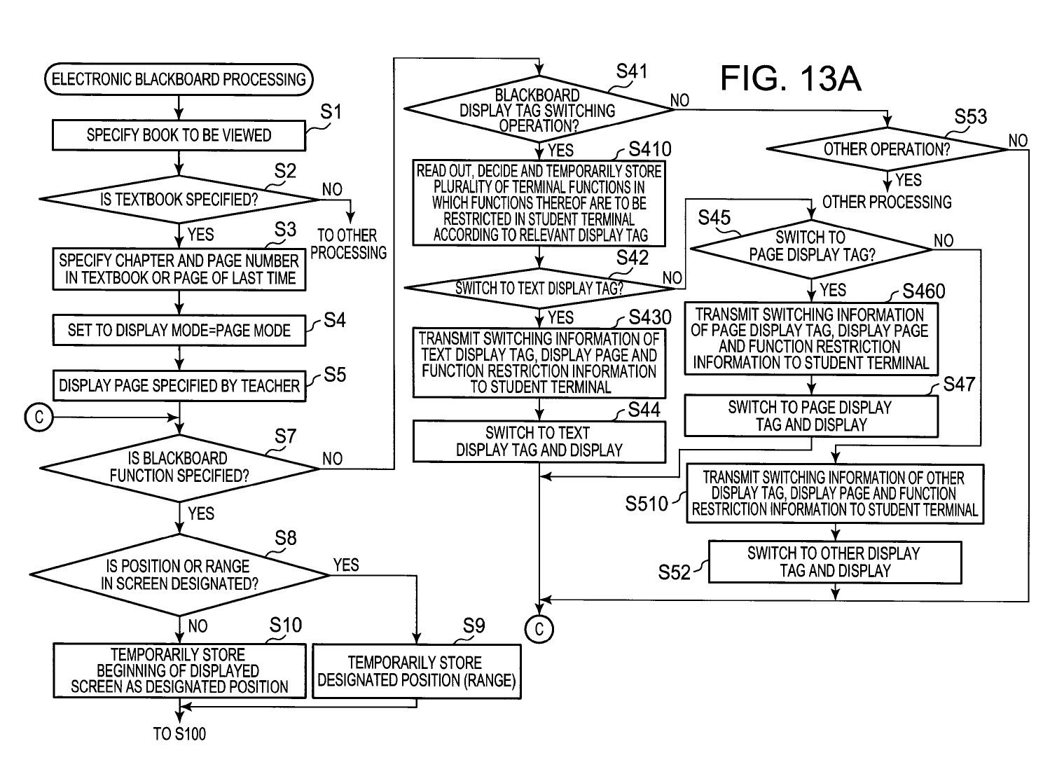

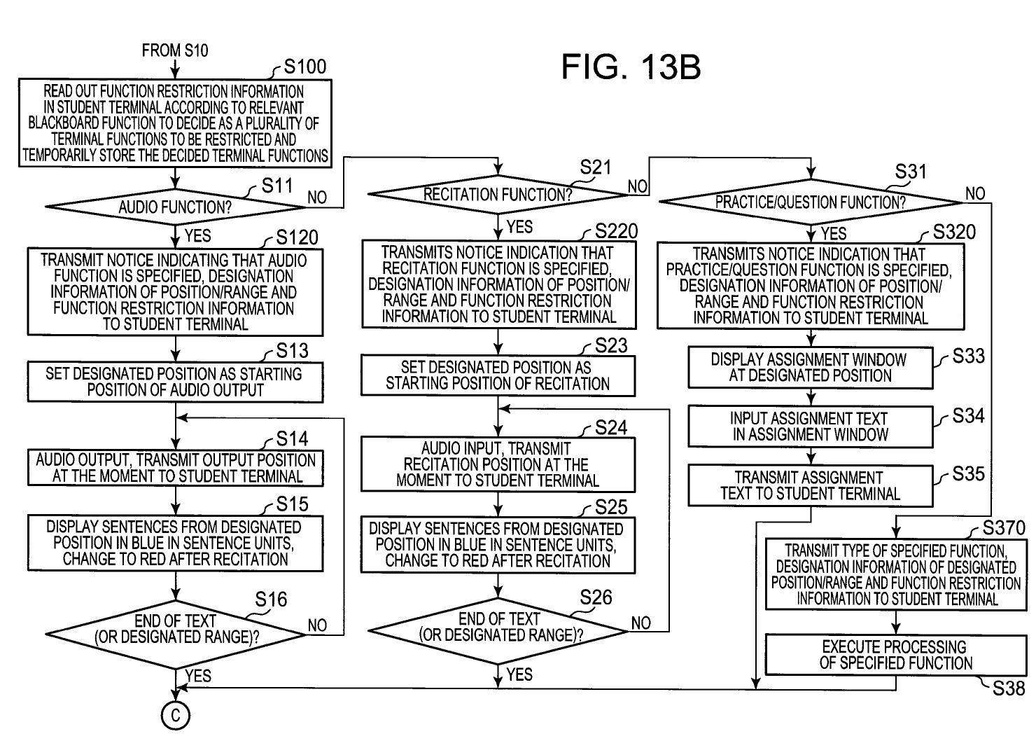

The blackboard-side class support program 340A is a program to make the CPU 35 execute the after-mentioned electronic blackboard processing (see FIGS. 13A and 13B).

Further, the blackboard function-wise function restriction table 442 and the blackboard tag-wise function restriction table 443 which are stored in the storage unit 44 of the student terminal 4 in the first embodiment are stored in the storage unit 34A.

Furthermore, as shown in FIG. 3, the terminal-side class support program 440A is stored in the storage unit 44A of the student terminal 4A.

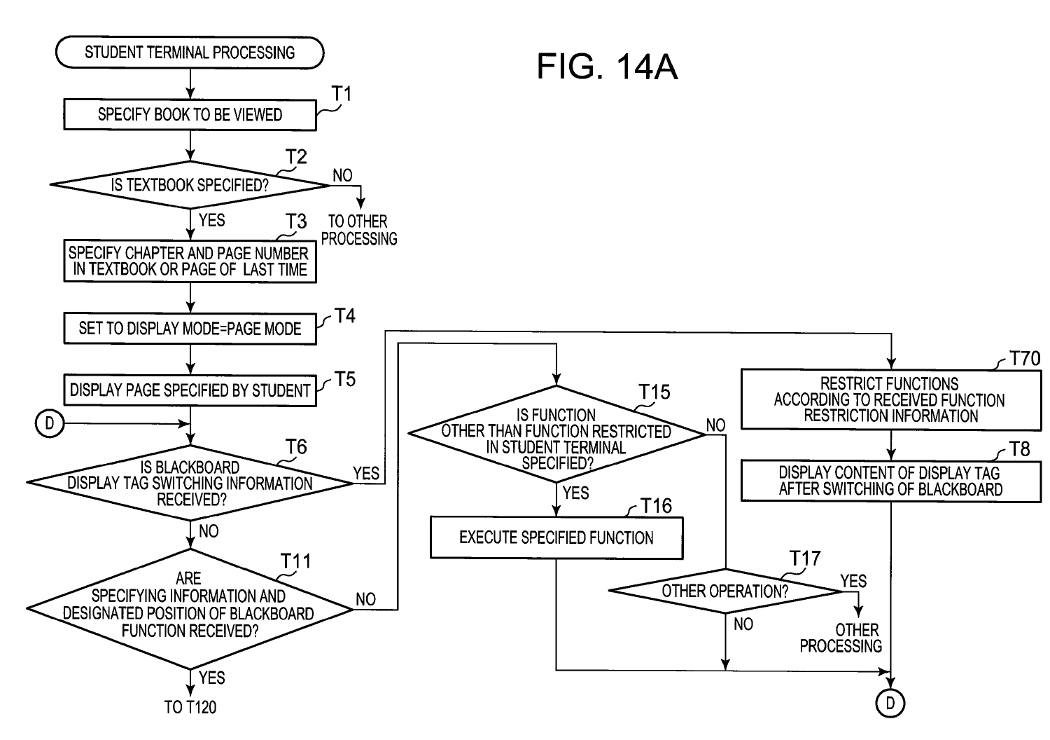

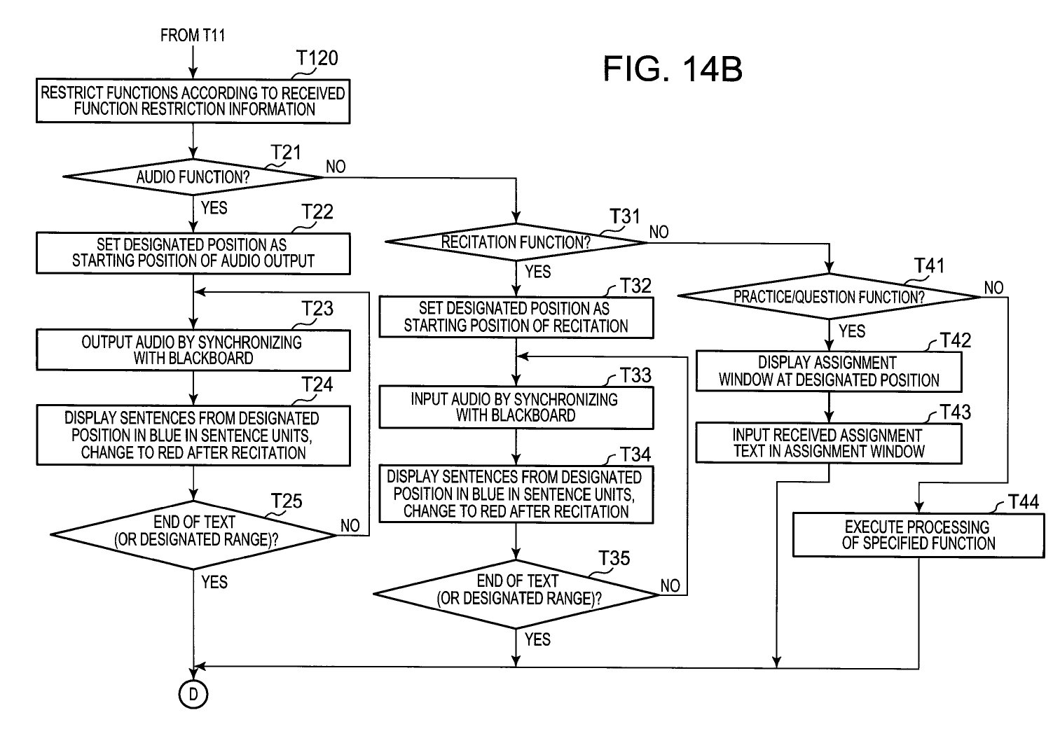

The terminal-side class support program 440A is a program to make the CPU 45 execute the after-mentioned student terminal processing (see FIGS. 14A and 14B).

Here, in the drawing, it is shown that the blackboard function-wise function restriction table 442 and the blackboard display tag-wise function restriction table 443 are stored in the storage unit 44A. However, it can be configured that the blackboard function-wise function restriction table 442 and the blackboard display tag-wise function restriction table 443 are not stored in the storage unit 44A.

### (Electronic Blackboard Processing)

Next, the electronic blackboard processing performed by the electronic blackboard 3A among the operations of the class support system 1A will be described with reference to FIG. 13A and FIG. 13B.

FIG. 13A and FIG. 13B are flowcharts for explaining an operation of the electronic blackboard processing which is executed by the CPU 35 reading out the blackboard side class support program 340A from the storage unit 34A. Here, because the electronic blackboard processing of the electronic blackboard 3A is partially same as the electronic blackboard processing described in the first embodiment, descriptions are given only for the processing different from the electronic blackboard processing in the first embodiment.

In the electronic blackboard processing of this embodiment, the CPU 35 reads out the types of restriction target functions (a plurality of restriction target functions corresponding to a specifying operation of a blackboard function) corresponding to the type of specified blackboard function from the blackboard function-wise function restriction table 442 to decide as the plurality of terminal functions target for restriction after the processing of steps S9 and S10 and temporarily stores them (step S100) and thereafter, moves on to step S11.

Further, when it is determined that the audio output function is specified in step S11 (step S11; Yes), the CPU 35 transmits a notice indicating that the audio output function is specified and the designated position (or designated range) in the text to the student terminal 4A (step S120) and thereafter, moves on to step S13. Furthermore, in step S120, the CPU 35 transmits the types of plurality of terminal functions which are restriction target decided in step S100 (types of a plurality of restriction target terminal functions corresponding to the audio output function) to the student terminal 4A and prohibits execution of the restriction target functions in the student terminal 4A, and also, the CPU 35 displays the soft keys K corresponding to the restriction target functions by shading them in yellow to show that the functions are restricted.

Moreover, when it is determined that the recitation function is specified in step S21 (step S21; Yes), the CPU 35 transmits a notice indicating that the reading (recitation) function is specified and the designated position (or designated range) in the text to the student terminal 4A (step S220) and thereafter, moves on to step S23. Further, in step S220, the CPU 35 transmits the types of restriction target functions (types of restriction target functions corresponding to the recitation function) which are temporarily stored in step S100 to the student terminal 4A and prohibits execution of the restriction target functions in the student terminal 4A, and also, the CPU 35 displays the soft keys K corresponding to the restriction target functions by shading them in yellow to shown that the functions are restricted.

Moreover, when it is determined that the practice/question function is specified in step S31 (step S31; Yes), the CPU 35 transmits a notice indicating that the practice/question function is specified and the designated position (or designated range) in the text to the student terminal 4A (step S320) and thereafter, moves on to step S33. Further, in step S320, the CPU 35 transmits the types of restriction target functions (types of restriction target functions corresponding to the practice/question function) which are temporarily stored in step S100 to the student terminal 4A and prohibits execution of the restriction target functions in the student terminal 4A, and also, the CPU 35 displays the soft keys K corresponding to the restriction target functions by shading them in yellow to show that the functions are restricted.

Moreover, when it is determined that the practice/question function is not specified in step S31 (step S31; No), the CPU 35 transmits the type of specified blackboard function and the designated position (or designated range) in the text to the student terminal 4A (step S370) and thereafter, moves on to step S38. Further, in step S370, the CPU 35 transmits the types of restriction target functions (types of restriction target functions corresponding to the specified blackboard function) which are temporarily stored in step S100 to the student terminal 4A and prohibits execution of the restriction target functions in the student terminal 4A, and also, the CPU 35 displays the soft keys K corresponding to the restriction target functions by shading them in yellow to show that the functions are restricted.

Moreover, when it is determined that switching operation is performed to a display tag Tg in step S41 (step S41; Yes), the CPU 35 reads out the types of restriction target functions corresponding to the display tag Tg after switching (types of restriction target functions corresponding to specifying operation of a display tag Tg) from the blackboard display tag-wise function restriction table 443 and temporarily stores them (step S410) and thereafter, moves on to step S42.

Further, when it is determined that switching operation is performed with respect to the text display tag Tg1 in step S42 (step S42; Yes), the CPU 35 transmits a notice indicating that switching to the text display tag Tg1 is performed and the page number of the page displayed at the moment to the student terminal 4A (step S430) and thereafter, moves on to step S44. Furthermore, in step S430, the CPU 35 transmits the types of restriction target functions (types of restriction target functions corresponding to the text display tag Tg1) which are temporarily stored in step S410 to the student terminal 4A, and prohibits execution of the restriction target functions in the student terminal 4A, and also, the CPU 35 displays the soft keys K corresponding to the restriction target functions by shading them in yellow to show that the functions are restricted.

Moreover, when it is determined that switching operation is performed with respect to the page display tag Tg2 in step S45 (step S45; Yes), the CPU 35 transmits a notice indicating that switching to the page display tag Tg2 is performed and the page number of the page displayed at the moment to the student terminal 4A (step S460) and thereafter, moves on to step S47. Further, in step S460, the CPU 35 transmits the types of restriction target functions (types of restriction target functions corresponding to the page display tag Tg2) which are temporarily stored in step S410 to the student terminal 4A and prohibits execution of restriction target functions in the student terminal 4A, and also, the CPU 35 displays the soft keys K corresponding to the restriction target functions by shading them in yellow to show that the functions are restricted.

Moreover, when it is determined that switching operation is not performed with respect to the page display tag Tg2 in step S45, that is, when switching operation is performed with respect to a display tag Tg other than the text display tag Tg1 and the page display tag Tg2 (step S45; No), the CPU 35 transmits the type of display tag Tg to which switching operation is performed and the page number of the page being displayed at the moment to the student terminal 4A (step S510) and thereafter, moves on to step S52. Further, in step S510, the CPU 35 transmits the types of restriction target functions (types of restriction target functions corresponding to the display tag Tg after switching) which are temporarily stored in step S410 to the student terminal 4A and prohibits execution of the restriction target functions in the student terminal 4A, and also, the CPU 35 displays the soft keys K corresponding to the restriction target functions to show that the functions are restricted.

### (Student Terminal Processing)

Next, the student terminal processing performed in the student terminal 4A among operations of the class support system 1A will be described with reference to FIG. 14A and FIG. 14B.

FIG. 14A and FIG. 14B are flowcharts for explaining an operation of the student terminal processing which is executed by the CPU 45 reading out the terminal side class support program 440 from the storage unit 44A. Here, the student terminal processing of the student terminal 4A is partially similar to the student terminal processing in the first embodiment. Therefore, description is only given to the processing different from the student terminal processing in the first embodiment.

In the student terminal processing in this embodiment, when it is determined that a notice indicating that execution of a blackboard function is specified and the designated position (or designated rage) in the text are received in step T11 (step T11; Yes), the CPU 45 prohibits execution of the restriction target functions received from the electronic blackboard 3A together at this time in the student terminal and displays the soft keys K corresponding to the restriction target functions by shading them in yellow to show that the functions are restricted (step T120) and moves on to step T23.

Moreover, when it is determined that a notice indicating that switching operation (specifying operation) is performed with respect to a display tag Tg and page number of the page displayed in the electronic blackboard 3A at the moment are received from the electronic blackboard 3A in step T6 (step T6; Yes), the CPU 45 prohibits execution of the restriction target functions which are received together at the same time from the electronic blackboard 3A in the student terminal and displays the soft keys K corresponding to the restriction target functions by shading them in yellow to show that the function are restricted (step T70), and moves on to step T8.

According to the above class support system 1A, advantages similar to that in the class support system 1 of the first embodiment can also be obtained.

### Third Embodiment

Next, the third embodiment of the present invention will be described. Here, when parts in the second embodiment corresponding to the same parts in the above described first embodiment are configured similarly among the two embodiments, same symbols are used for those parts and descriptions thereof are omitted.

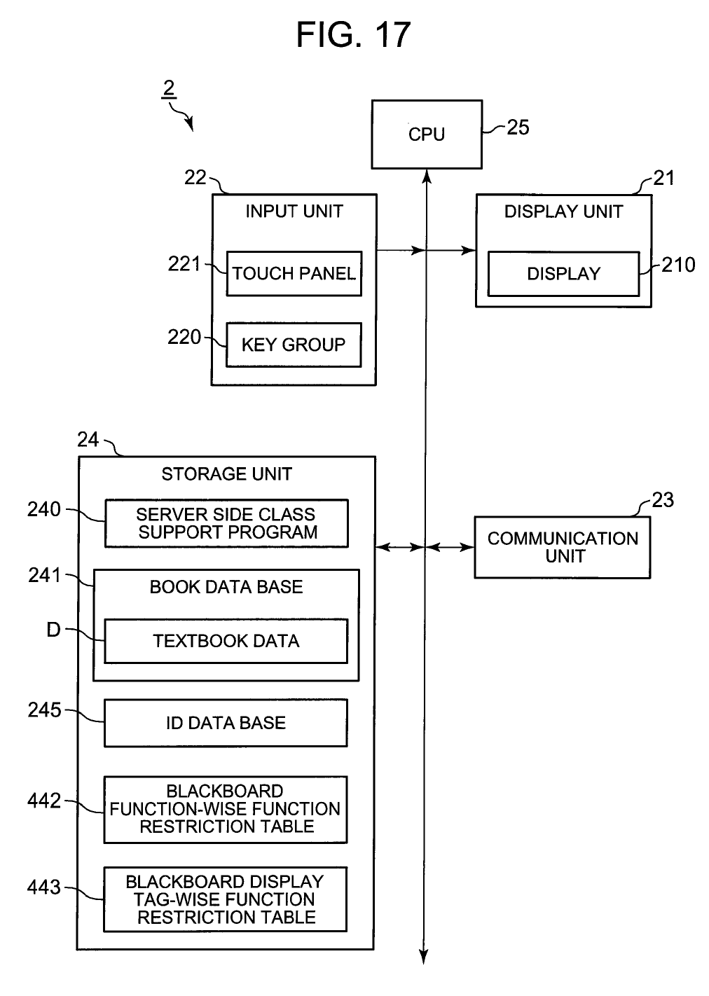

As shown in FIG. 1, the class support system 1B according to this embodiment is provided with an electronic blackboard 3B, student terminals 4B and a server 2 (see FIG. 17). However, the server 2 is omitted in FIG. 1.

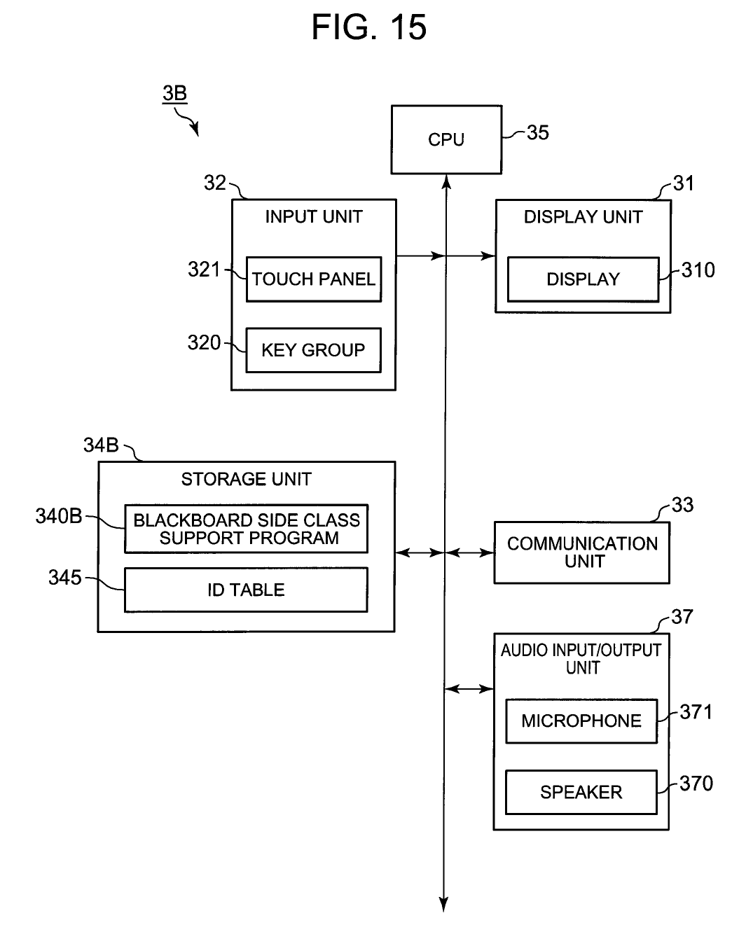

As shown in FIG. 15, the blackboard side class support program 340B and the ID table 345 are stored in the storage unit 34B of the electronic blackboard 3B.

The blackboard-side class support program 340B is to carry out processing according to information transmitted from the server 2.

The blackboard ID of the electronic blackboard and the classroom ID of the classroom where the electronic blackboard belongs to are stored in the ID table 345 by being corresponded to each other.

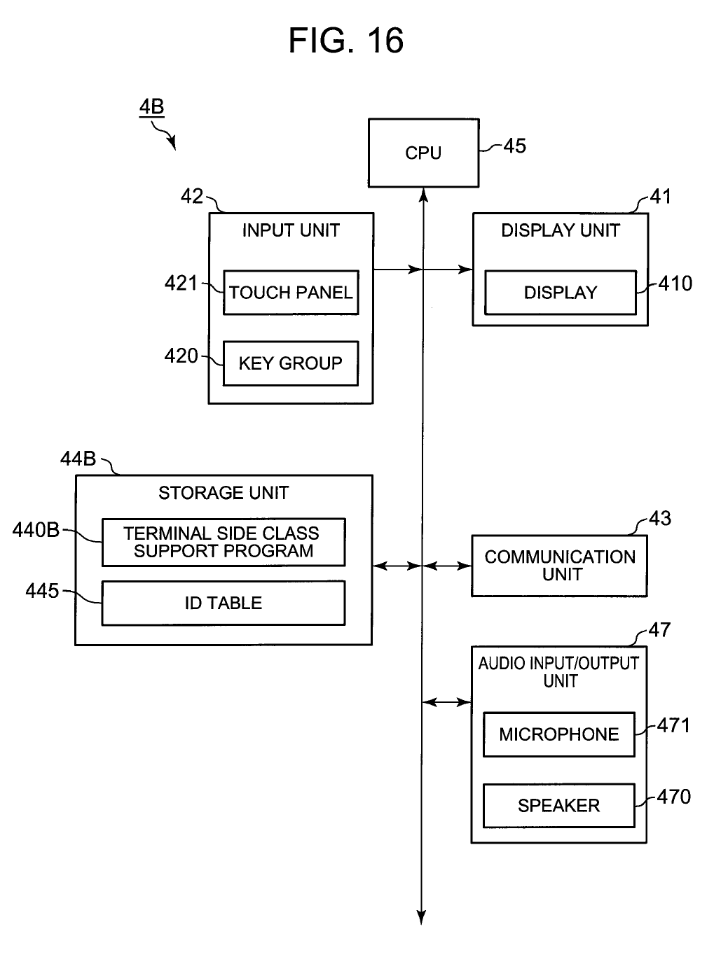

Further, as shown in FIG. 16, the terminal side class support program 440B and the ID table 445 are stored in the storage unit 44B of the student terminal 4B.

The terminal side class support program 440B is to carry out processing according to information transmitted from the server 2.

The terminal ID of the student terminal and the classroom ID of the classroom where the student terminal belongs to are stored in the ID table 445 by being corresponded to each other.

### [Server]

The server 2 is for providing functions and data to a plurality of electronic blackboards 3B and student terminals 4B in a school. As shown in FIG. 17, the server 2 is constituted with a display unit 21, an input unit 22, a communication unit 23, a storage unit 24, a CPU 25 and so forth.

The display unit 21 includes a display 210, and various types of information are to be displayed in the display 210 based on display signals input from the CPU 25. Here, the display 210 in this embodiment is formed integrally with a so-called touch panel 221 and touch operations performed by a user can be received.

The input unit 22 includes a group of keys 220 and the above mentioned touch panel 221, and outputs signals corresponding to pushed keys and pushed positions in the touch panel to the CPU 25.

The communication unit 23 is for carrying out data communication with a plurality of electronic blackboards 3 and student terminals 4, and in this embodiment, a wireless communication is carried out.

The storage unit 24 is a memory for storing programs and data for realizing various types of function in the server 2 and functions as a working area of the CPU 25. In this embodiment, a server side class support program 240, a book data base 241, an ID data base 245, a blackboard function-wise function restriction table 442, a blackboard display tag-wise function restriction table 443 and the like are stored in the storage unit 24.

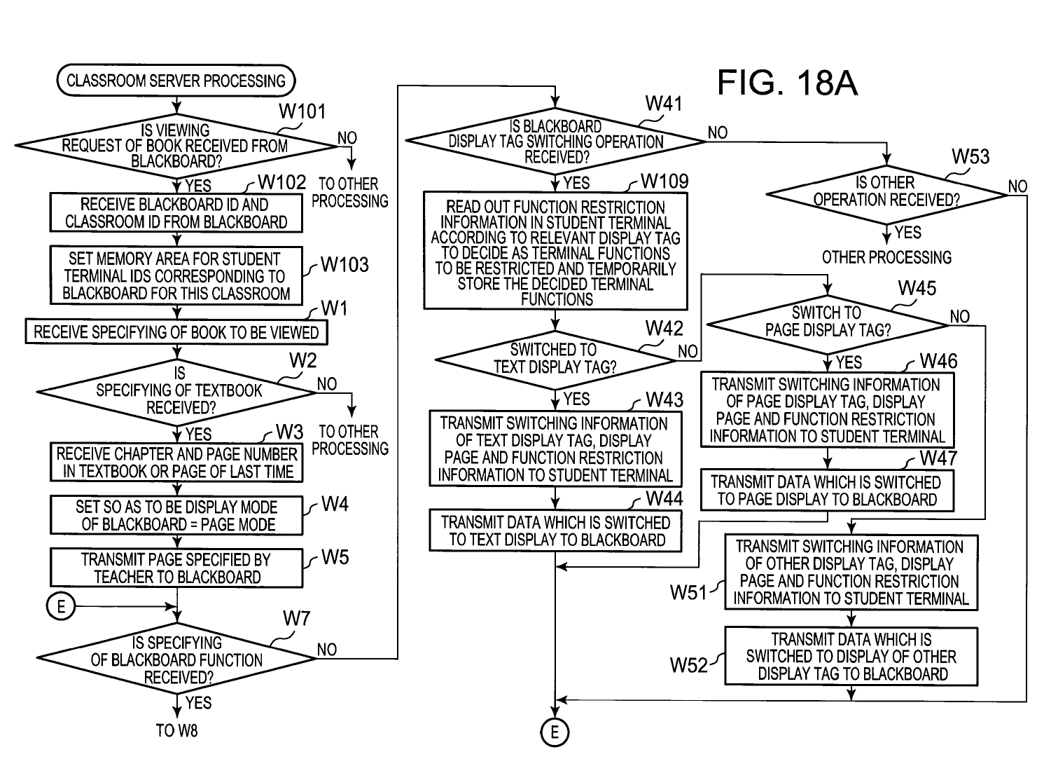

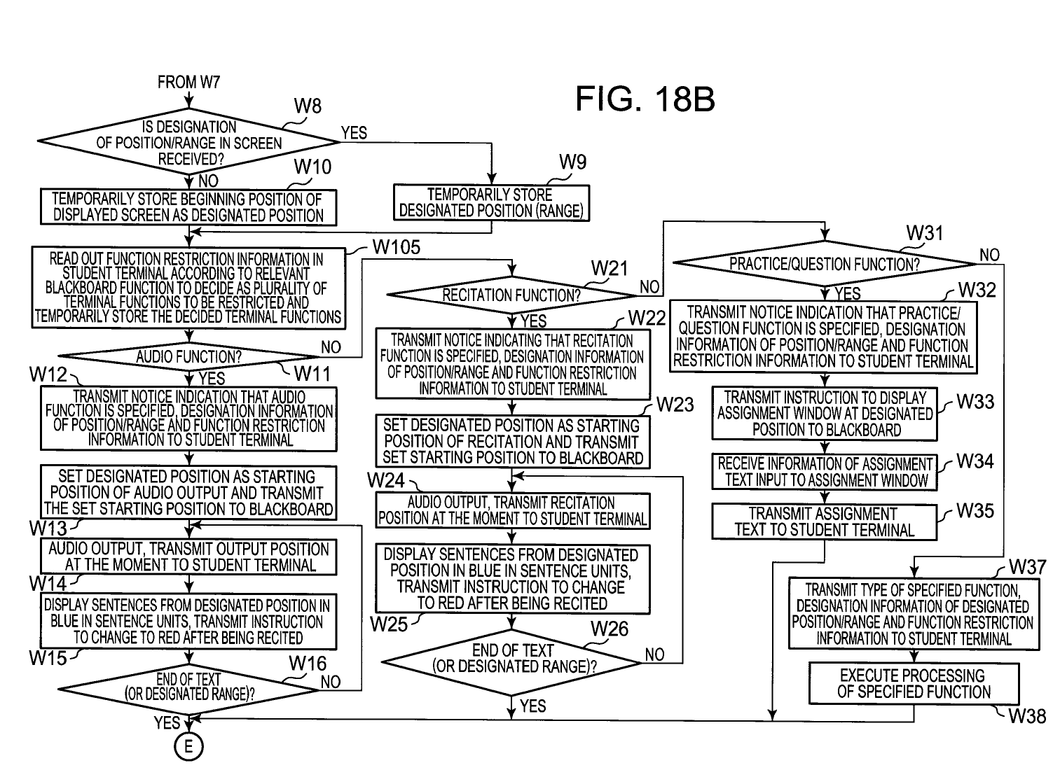

The server side class support program 240 is a program to make the CPU 25 execute the after-mentioned classroom server processing (see FIGS. 18A and 18B).

Data regarding books to be used in classes are stored in the book data base 241, and for example, textbook data D regarding each textbook is stored.

A plurality of ID codes of electronic blackboards 3 and student terminals 4 which have access to the server 2 (hereinafter, called blackboard ID and terminal ID) and a plurality of ID codes of classrooms where the electronic blackboards 3 and the student terminals 4 belong to (hereinafter, called classroom ID) are stored in the ID data base 245 by being corresponded to each other.

The CPU 25 integrally controls the server 2 by executing the processing based on a predetermined program according to input instructions and performing transferring and the like of instructions and data to each of the functional parts. In particular, the CPU 25 reads out various types of programs stored in the storage unit 24 according to operation signals and the like input from the input unit 22 and executes processing according to the programs. Then, the CPU 25 arbitrarily outputs the processing results to the display unit 21.

### (Classroom Server Processing)

Next, the classroom server processing performed by the server 2 among operations of the class support system 1B will be described with reference to FIG. 18A and FIG. 18B.

FIG. 18A and FIG. 18B are flowcharts for explaining an operation of the classroom server processing which is executed by the CPU 25 reading out the server side class support program 240 from the storage unit 24.

In the classroom server processing, the CPU 25 first determines whether any of the electronic blackboards 3B is to receive a viewing request of a book by teacher's operation (step W101). When it is determined that the viewing request is not to be received (step W101; No), the process moves on to other processing.

Further, when it is determined that any of the electronic blackboards 3B received a viewing request of a book in step W101 (step W101; Yes), the CPU 25 receives the blackboard ID and the classroom ID stored in the ID table 345 of the electronic blackboard 3S from the electronic blackboard 3B which received the viewing request (hereinafter, the electronic blackboard 3S will be discriminated from the other electronic blackboards 3B) (step W102).

Next, the CPU 25 prepares a working area in the storage unit 24 for the electronic blackboard 3S and the student terminals 4B corresponding to the electronic blackboard 3S (hereinafter, the student terminal 4S will be discriminated from other student terminals 4B) for a class to be held in the classroom indicated by the received classroom ID (step W103).

Next, the CPU 25 receives specified information of a book to be viewed from the electronic blackboard 3S (step W1) and thereafter, determines whether a notice indicating that the classroom is specified is received (step W2). When it is determined that the notice indicating that the classroom is specified is not received (step W2; No), the process moves on to other processing.

Further, when it is determined that a notice indicating that a textbook is specified is received in step W2 (step W2; Yes), the CPU 25 receives a specifying operation of a chapter and a page number in the textbook or a specifying operation of the page which is displayed last in the previous electronic blackboard processing from a user (teacher) via the electronic blackboard 3S (step W3).

Next, the CPU 25 sets the display mode of the display 310 in the electronic blackboard 3S and the student terminal 4S to the page mode (step W4).

Then, the CPU 25 transmits textbook data D to the electronic blackboard 3S and the student terminal 4S, and displays the page specified in step W3 among the pages in the textbook (hereinafter, called specified textbook) which is specified in step W1 in the displays 310 and 410 of the electronic blackboard 3S and the student terminal 4S (step W5).

Further, at this time, the CPU 25 displays a plurality of display tags Tg for switching the display content along the right edge of the displays 310 and 410 of the electronic blackboard 3S and the student terminal 4S. More in particular, at this time, the CPU 25 displays the page display tag Tg2, the text display tag Tg1, the reference display tag Tg3 and so forth as the plurality of display tags Tg and displays the page display tag Tg2 in a selected state.

At this time, the CPU 25 displays a plurality of soft keys K for instructing execution of a predetermined blackboard function along the lower edge of the display 310 of the electronic blackboard 3S and displays soft keys K for instructing execution of terminal functions along the lower edge of the display 410 in the student terminal 4S.

Next, the CPU 25 determines whether a notice indicating that the execution of a blackboard function is specified in the electronic blackboard 3S (step W7).

When it is determined that a notice indicating that the execution of a blackboard function is specified is received in step W7 (step W7; Yes), the CPU 25 determines whether a notice indicating that a position or a range in the text displayed in the electronic blackboard 3S is designated is received (step W8).

When it is determined that the notice indicating that a position or a range in the text is designated is received from the electronic blackboard 3S in step W8 (step W8; Yes), the CPU 25 temporarily stores the designated position or the designate range (step W9) and thereafter, moves on to the after-mentioned step W11.

Further, when it is determined that the notice indicating that a position or a range in the text is designated is not received from the electronic blackboard 3S in step W8 (step W8; No), the CPU 25 temporarily stores the beginning of the text displayed in the electronic blackboard 3S as the designated position (step W10).

Next, the CPU 25 reads out the types of restriction target functions (types of restriction target functions corresponding to the specifying operation of a blackboard function) corresponding to the type of specified blackboard function from the blackboard function-wise function restriction table 442 and decides the read out types of restriction target functions as a plurality of terminal functions in which their functions are to be restricted in the student terminal and temporarily stores the read out types of restriction target functions (step W105).

Next, the CPU 25 determines whether the audio output function is specified as the blackboard function (step W11).

When it is determined that the audio output function is specified in step W11 (step W11; Yes), the CPU 25 transmits a notice indicating that the audio output function is specified and the designated position (or designated range) in the text to the student terminal 4S (step W12). Further, in step W12, the CPU 25 transmits the types of restriction target functions (types of restriction target functions corresponding to the audio output function) which is temporarily stored in step W105 to the student terminal 4S and prohibits execution of the restriction target functions in the student terminal 4S, and also, the CPU 25 displays the soft keys K corresponding to the restriction target functions by shading them in yellow to show that the functions are restricted.

Next, the CPU 25 sets the designated position (or the beginning of the designated range) as the starting position of audio output and transmits the set starting position to the electronic blackboard 3S (step W13), and then, makes the speaker 370 of the electronic blackboard 3S output the audio (step W14). Furthermore, the CPU 25 transmits the position information of the text part being audio output at the moment to the student terminal 4S.

Next, the CPU 25 displays the sentence which is target for audio output in blue in the electronic blackboard 3S and the student terminal 4S and changes the display color of the sentence part where the audio output thereof is done to red (step W15).

Then, the CPU 25 determines whether audio output is performed to the end of the text (or the end of the designated range) (step W16). When it is determined that audio output is not performed to the end of the text (or the end of the designated range) (step W16; No), the CPU 25 moves on to the above step W14, and on the other hand, when it is determined that audio output is performed to the end of the text (or the end of the designated range) (step W16; Yes), the CPU 25 moves on to the above step W7.

Further, when it is determined that the audio output function is not specified in step W11 (step W11; No), the CPU 25 determines whether the recitation function is specified (step W21).

When it is determined that the recitation function is specified in step W21 (step W21; Yes), the CPU 25 transmits a notice indicating that the recitation function is specified and the designated position (or designated range) in the text to the student terminal 4S (step W22). Further, in step W22, the CPU 25 transmits the types of restriction target functions (types of restriction target functions corresponding to the recitation function) which are temporarily stored in step W105 to the student terminal 4S and prohibits execution of the restriction target functions in the student terminal 4S, and also, the CPU 25 displays the soft keys corresponding to the restriction target functions by shading them in yellow to show that the functions are restricted.

Next, the CPU 25 sets the designated position (or the beginning of the designated range) as the starting position of recitation and transmits the set starting position to the electronic blackboard 3S (step W23) and makes the microphone 371 of the electronic blackboard 3S input the audio to perform audio recognition (step W24). Further, at this time, the CPU 25 transmits the position information of the text part being recited at the moment to the student terminal 4S.

Next, the CPU 25 displays the sentence which is target for recitation in blue in the electronic blackboard 3S and the student terminal 4S and changes the display color of the sentence part where recitation thereof is done to red (step W25).

Then, the CPU 25 determines whether recitation is performed to the end of the text (or to the end of the designated range) (step W26). When it is determined that the recitation is not performed to the end of the text (or to the end of the designated range) (step W26; No), the CPU 25 moves on to the above step W24, and on the other hand, when it is determined that the recitation is was performed to the end of the text (or to the end of the designated range) (step W26; Yes), the CPU 25 moves on to the above step W7.

Moreover, when it is determined that the recitation function is not specified in step W21 (step W21; No), the CPU 25 determines whether the practice/question function is specified (step W31).

When it is determined that the practice/question function is specified in step W31 (step W31; Yes), the CPU 25 transmits a notice indicating that the practice/question function is specified and the designated position (or designated range) in the text to the student terminal 4S (step W32). Further, in step W32, the CPU 25 transmits the types of restriction target functions (the types of restriction target functions corresponding to the practice/question function) which are temporarily stored in step W105 to the student terminal 4S and prohibits execution of the restriction target functions in the student terminal 4S, and also, the CPU 25 displays the soft keys K corresponding to the restriction target functions by shading them in yellow to show that the functions are restricted.

Next, the CPU 25 displays an assignment window W at each designated position (or at the end of the designated range) in the electronic blackboard 3S and the student terminal 4S (step W33).

Next, the CPU 25 displays an assignment text in the assignment window W of the electronic blackboard 3S based on the received content of the input operation performed in the electronic blackboard 3S (step W34). More in particular, at this time, the CPU 25 displays an assignment described in the textbook in the assignment window W when the practice function is specified. On the other hand, the CPU 25 displays an assignment text input by a user (teacher), an assignment text which is target for copy and paste operation or the like in the assignment window W when the question function is specified.

Next, the CPU 25 transmits the assignment text to the student terminal 4S and displays the assignment text in the assignment window W of the student terminal 4S (step W35) and thereafter, moves on to the above step W7.

Further, when it is determined that the practice/question function is not specified in step W31 (step W31; No), the CPU 25 transmits the type of specified blackboard function and the designated position (or designated range) in the text to the student terminal 4S (step W37).

Then, the CPU 25 executes the processing of the specified function (step W38) and moves on to the above mentioned step W7. Here, page switching function, zoom function, handwriting input function, marker function, dictionary function and the like are suggested as the functions to be executed in step W38.

Moreover, when it is determined that the notice indicating that execution of a blackboard function is specified is not received in step W7 (step W7; No), the CPU 25 determines whether a notice indicating that switching operation of display tags Tg is performed in the electronic blackboard 3S is received (step W41).

When it is determined that the notice indicating that switching operation of display tags Tg is performed is received in step W41 (step W41; Yes), the CPU 25 reads out the types of restriction target functions (types of restriction target functions corresponding to the specifying operation of a display tag Tg) corresponding to the display tag Tg after switching from the blackboard display tag-wise function restriction table 443 and temporarily stores the read out restriction target functions (step W109).

Next, the CPU 25 determines whether switching operation is performed with respect to the text display tag Tg1 (step W42).

When it is determined that switching operation is performed with respect to the text display tag Tg1 in step W42 (step W42; Yes), the CPU 25 transmits a notice indicating that switching to the text display tag Tg1 is performed and the page number of the page being displayed at the moment to the student terminal 4S (step W43). Further, in step W43, the CPU 25 transmits the types of restriction target functions (types of restriction target functions corresponding to the text display tag Tg1) which are temporarily stored in step W109 and prohibits execution of restriction target function in the student terminal 4S, and also, the CPU 25 displays the soft keys K corresponding to the restriction target functions by shading them in yellow to show that the functions are restricted.

Next, the CPU 25 sets the display mode of the displays 310 and 410 in the electronic blackboard 3S and the student terminal 4S to the text mode and transmits the text in the page being displayed at the moment to the electronic blackboard 3S and the student terminal 4S to display the text in the displays 310 and 410 (step W44) and moves on to the above step W7.

Moreover, when it is determined that switching operation is not performed with respect to the text display tag Tg1 in step W42 (step W42; No), the CPU 25 determines whether switching operation is performed with respect to the page display tag Tg2 (step W45).

When it is determined that switching operation is performed with respect to the page display tag Tg2 in step W45 (step W45; Yes), the CPU 25 transmits a notice indicating that switching to the page display tag Tg2 is performed and the page number of the page being displayed at the moment to the student terminal 4S (step W46). Further, in step W46, the CPU 25 transmits the types of restriction target functions (types of restriction target functions corresponding to the page display tag Tg2) which are temporarily stored in step W109 to the student terminal 4S and prohibits execution of the restriction target functions in the student terminal 4S, and also, the CPU 25 displays the soft keys K corresponding to the restriction target functions by shading them in yellow to show that the functions are restricted.

Next, the CPU 25 sets the display mode of the displays 310 and 410 in the electronic blackboard 3S and the student terminal 4S to the page mode and transmits the page being displayed at the moment to the electronic blackboard 3S and the student terminal 4S to display the page in the displays 310 and 410 as it is (step W47), and moves on to the above step W7.

Moreover, when it is determined that switching operation is not performed with respect to the page display tag Tg2 in step W45, that is, when it is determined that switching operation is performed with respect to a display tag Tg other than the text display tag Tg1 and the page display tag Tg2 (step W45; No), the CPU 25 transmits the type of the display tag Tg to which switching operation is performed and the page number of the page being displayed at the moment to the student terminal 4S (step W51), displays the content of the display tag Tg in the displays 310 and 410 in the electronic blackboard 3S and the student terminal 4S (step W52) and moves on to the above step W7. Further, in step W51, the CPU 25 transmits the types of restriction target functions (types of restriction target functions corresponding to the display tag Tg) which are temporarily stored in step W109 to the student terminal 4S and prohibits execution of the restriction target functions in the student terminal 4S, and also, the CPU 25 displays the soft keys K corresponding to the restriction target functions by shading them in yellow to show that the functions are limited.

Moreover, when it is determined that a notice indicating that switching operation of display tags Tg is performed is not received in step W41 (step W41; No), the CPU 25 determines whether a notice indication that other operation is performed is received (step W53). When it is determined that the notice indicating that other operation is performed is received (step W53; Yes), the CPU 25 performs the processing according to the operation, and on the other hand, when it is determined that the notice indicating that other operation is performed is not received (step W53; No), the CPU 25 moves on to the above step W7.

According to the above described class support system 1B, advantages similar to that in the class support system 1 according to the first embodiment can also be obtained.

Here, regarding detail configurations and detail operations of components in the class support system 1 of the above embodiments, it is needless to say that they can be arbitrarily modified within the scope of the present invention.

For example, in the above embodiments, description is given assuming that the terminal side class support program 440 is stored in the student terminal 4. However, the terminal side class support program 440 can be stored in storage medium such as detachable memory cards and CD.

Moreover, in the first and second embodiments, description is given assuming that the student terminal 4 detects operations in the electronic blackboard 3 based on information transmitted from the electronic blackboard 3. However, the detection may be carried out by other means such as monitoring the display content of the electronic blackboard 3 in real time. Similarly, in the third embodiment, description is given assuming that the server 2 detects operations in the electronic blackboard 3 based on information transmitted from the electronic blackboard 3. However, the detection may be carried out by other means such as monitoring the display content of the electronic blackboard 3 in real time.

Moreover, description is given assuming the electronic blackboard 3 is provided with the display 310. However, the electronic blackboard 3 can be provided with a projector instead.

In the above, number of embodiments of the present invention are described. However, the scope of the present invention is not limited to the above described embodiments, and the present invention includes the scope of the invention described in the claims and the equivalents thereof.

The present U.S. patent application claims a priority under the Paris Convention of Japanese paten application No. 2011-077410 filed on Mar. 31, 2011, which shall be a basis of correction of an incorrect translation.

Although various exemplary embodiments have been shown and described, the invention is not limited to the embodiments shown. Therefore, the scope of the invention is intended to be limited solely by the scope of the claims that follow.

What is claimed is:

1. An electronic blackboard which communicates with a student terminal which executes a plurality of terminal functions, comprising:
a blackboard function execution unit to execute any of a plurality of blackboard functions according to a user's operation;
a restriction target function deciding unit to decide types of a plurality of terminal functions in which functions thereof are to be restricted in the student terminal according to a type of blackboard function to be executed; and
a restriction target functions transmission unit to transmit the types of the plurality of terminal functions in which functions thereof are to be restricted, which are decided by the restriction target function deciding unit, to the student terminal.

2. The electronic blackboard as claimed in claim 1, further comprising a restriction target function storing unit to store the types of the plurality of terminal functions in which functions thereof are to be restricted in the student terminal among the plurality of terminal functions so as to be corresponded with each type of the plurality of blackboard functions, wherein
the restriction target function deciding unit reads out types of terminal functions corresponding to the type of blackboard function to be executed from the restriction target function storing unit to decide the read out types of terminal functions as the terminal functions in which functions thereof are to be restricted.

3. The electronic blackboard as claimed in claim 1, wherein
the blackboard function to be executed is an audio output function, and
the restriction target function deciding unit includes at least two of a page switching function, an enlarging function, a reducing function, a dictionary function and a recitation function in the plurality of terminal functions in which functions thereof are decided to be restricted in the student terminal.

4. The electronic blackboard as claimed in claim 1, wherein
the blackboard function to be executed is a recitation function, and
the restriction target function deciding unit includes at least two of a handwriting input function, an marker function, an audio output function, a dictionary function and a recitation function in the plurality of terminal functions in which functions thereof are decided to be restricted in the student terminal.

5. The electronic blackboard as claimed in claim 1, wherein
the blackboard function to be executed is a practice function, and
the restriction target function deciding unit includes an audio output function and a recitation function in the plurality of terminal functions in which functions thereof are decided to be restricted in the student terminal.

6. The electronic blackboard as claimed in claim 1, wherein
the blackboard function to be executed is a question function, and
the restriction target function deciding unit includes at least two of a page switching function, an audio output function, a dictionary function and a recitation function in the plurality of terminal functions in which functions thereof are decided to be restricted in the student terminal.

7. An electronic blackboard which communicates with a student terminal which executes a plurality of terminal functions, comprising:
a blackboard display switching execution unit to execute any of a plurality of blackboard display switching according to a user's operation;
a switched state restriction target function deciding unit to decide types of a plurality of terminal functions in which functions thereof are to be restricted in the student terminal according to a type of blackboard display switching to be executed; and
a restriction target functions transmission unit to transmit the types of the plurality of terminal functions in which functions thereof are to be restricted, which are decided by the switched state restriction target function deciding unit, to the student terminal.

8. The electronic blackboard as claimed in claim 7, further comprising a switched state restriction target function storing unit to store the types of the plurality of terminal functions in which functions thereof are to be restricted in the student terminal among the plurality of terminal functions so as to be corresponded with each type of the plurality of blackboard display switching, wherein
the switched state restriction target function deciding unit reads out types of terminal functions corresponding to the type of blackboard display switching to be executed from the switched state restriction target function storing unit to decide the read out types of terminal functions as the terminal functions in which functions thereof are to be restricted.

9. A student terminal which executes a plurality of terminal functions and communicates with an electronic blackboard, comprising:
a blackboard function receiving unit to receive a type of blackboard function to be executed in the electronic blackboard;
a restriction target function deciding unit to decide types of a plurality of terminal functions in which functions thereof are to be restricted in the student terminal according to the type of blackboard function to be executed; and
a restriction target function prohibiting unit to prohibit execution of the plurality of terminal functions in which functions thereof are to be restricted, which are decided by the restriction function deciding unit.

10. The student terminal as claimed in claim 9, further comprising a restriction target function storing unit to store the types of the plurality of terminal functions in which functions thereof are to be restricted in the student terminal among the plurality of terminal functions so as to be corresponded with each type of the plurality of blackboard functions, wherein
the restriction target function deciding unit reads out types of terminal functions corresponding to the type of blackboard function to be executed from the restriction target function storing unit to decide the read out types of terminal functions as the terminal functions in which functions thereof are to be restricted.

11. The student terminal as claimed in claim 9, wherein
the blackboard function to be executed is an audio output function, and
the restriction target function deciding unit includes at least two of a page switching function, an enlarging function, a reducing function, a dictionary function and a recitation function in the plurality of terminal functions in which functions thereof are decided to be restricted in the student terminal.

12. The student terminal as claimed in claim 9, wherein
the blackboard function to be executed is a recitation function, and
the restriction target function deciding unit includes at least two of a handwriting input function, an marker function, an audio output function, a dictionary function and a recitation function in the plurality of terminal functions in which functions thereof are decided to be restricted in the student terminal.

13. The student terminal as claimed in claim 9, wherein
the blackboard function to be executed is a practice function, and
the restriction target function deciding unit includes at least two of an audio output function and a recitation function in the plurality of terminal functions in which functions thereof are decided to be restricted in the student terminal.

14. The student terminal as claimed in claim 9, wherein
the blackboard function to be executed is a question function, and
the restriction target function deciding unit includes at least two of a page switching function, an audio output function, a dictionary function and a recitation function in the plurality of terminal functions in which functions thereof are decided to be restricted in the student terminal.

15. A server which communicates respectively with an electronic blackboard and a student terminal which executes a plurality of terminal functions, comprising:
a blackboard function receiver unit to receive a type of blackboard function to be executed in the electronic blackboard among a plurality of blackboard functions;
a restriction target function deciding unit to decide types of a plurality of terminal functions in which functions thereof are to be restricted in the student terminal according to the type of blackboard function which is received; and
a restriction target functions transmission unit to transmit the types of the plurality of terminal function in which functions thereof are to be restricted, which are decided by the restriction target function deciding unit, to the student terminal.

16. A terminal function restriction method in an electronic blackboard which communicates with a student terminal which executes a plurality of terminal functions, comprising:
executing any of a plurality of blackboard functions according to a user's operation;
deciding types of a plurality of terminal functions in which functions thereof are to be restricted in the student terminal according to a type of blackboard function to be executed; and
transmitting the types of the plurality of terminal functions in which functions thereof are to be restricted, which are decided in the deciding, to the student terminal.

17. An terminal function restriction method in an electronic blackboard which communicates with a student terminal which executes a plurality of terminal functions, comprising:
executing any of a plurality of blackboard display switching according to a user's operation;
deciding types of a plurality of terminal functions in which functions thereof are to be restricted in the student terminal according to a type of blackboard display switching to be executed; and
transmitting the types of the plurality of terminal functions in which functions thereof are to be restricted, which are decided in the deciding, to the student terminal.

18. A terminal function restriction method in a student terminal which executes a plurality of terminal functions and communicates with an electronic blackboard, comprising:
receiving a type of blackboard function to be executed in the electronic blackboard;
deciding types of a plurality of terminal functions in which functions thereof are to be restricted in the student terminal according to the type of blackboard function to be executed; and
prohibiting execution of the plurality of terminal function in which functions thereof are to be restricted, which are decided in the deciding.

19. A terminal function restriction method in a server which communicates respectively with an electronic blackboard and a student terminal which executes a plurality of terminal functions, comprising:
receiving a type of blackboard function to be executed in the electronic blackboard among a plurality of blackboard functions;
deciding types of a plurality of terminal functions in which functions thereof are to be restricted in the student terminal according to the type of blackboard function which is received; and
transmitting the types of the plurality of terminal function in which functions thereof are to be restricted, which are decided in the deciding, to the student terminal.

20. A recording medium which records a program for controlling a computer of an electronic blackboard which communicates with a student terminal which executes a plurality of terminal functions so as to function as:
a blackboard function execution unit to execute any of a plurality of blackboard functions according to a user's operation;
a restriction target function deciding unit to decide types of a plurality of terminal functions in which functions thereof are to be restricted in the student terminal according to a type of blackboard function to be executed; and
a restriction target functions transmission unit to transmit the types of the plurality of terminal function in which functions thereof are to be restricted, which are decided by the restriction target function deciding unit, to the student terminal.

21. A recording medium which records a program for controlling a computer of an electronic blackboard which communicates with a student terminal which executes a plurality of terminal functions so as to function as:
a blackboard display switching execution unit to execute any of a plurality of blackboard display switching according to a user's operation;
a switched state restriction target function deciding unit to decide types of a plurality of terminal functions in which functions thereof are to be restricted in the student terminal according to a type of the blackboard display switching to be executed; and
a restriction target functions transmission unit to transmit the types of the plurality of terminal function in which functions thereof are to be restricted, which are decided by the switched state restriction target function deciding unit, to the student terminal.

22. A recording medium which records a program for controlling a computer of a student terminal which executes a plurality of terminal functions and communicates with an electronic blackboard so as to function as:
a blackboard function receiving unit to receive a type of blackboard function to be executed in the electronic blackboard;
a restriction target function deciding unit to decide types of a plurality of terminal functions in which functions thereof are to be restricted in the student terminal according to the type of blackboard function to be executed; and
a restriction target function prohibiting unit to prohibit execution of the plurality of terminal functions in which functions thereof are to be restricted, which are decided by the restriction function deciding unit.

23. A recording medium which records a program for controlling a computer of a server which communicates respectively with an electronic blackboard and a student terminal which executes a plurality of terminal functions so as to function as:
a blackboard function receiver unit to receive a type of blackboard function to be executed in the electronic blackboard among a plurality of blackboard functions;
a restriction target function deciding unit to decide types of a plurality of terminal functions in which functions thereof are to be restricted in the student terminal according to the type of blackboard function which is received; and
a restriction target functions transmission unit to transmit the types of the plurality of terminal function in which functions thereof are to be restricted, which are decided by the restriction function deciding unit, to the student terminal.
